(19) United States
(12) Patent Application Publication
(10) Pub. No.: US 2024/0244547 A1
(43) Pub. Date: Jul. 18, 2024

(54) DUAL CONNECTIVITY ENHANCEMENTS IN INTEGRATED ACCESS AND BACKHAUL

(71) Applicant: Lenovo (Singapore) Pte. Ltd., New Tech Park (SG)

(72) Inventors: Majid Ghanbarinejad, Chicago, IL (US); Vijay Nangia, Woodridge, IL (US); Hyejung Jung, Northbrook, IL (US)

(21) Appl. No.: 18/560,330

(22) PCT Filed: May 10, 2022
(86) PCT No.: PCT/IB2022/054343

§ 371 Date: Nov. 10, 2023

Related U.S. Application Data
(60) Provisional application No. 63/186,727, filed on May 10, 2021.

(51) Int. Cl. H04W 56/00; H04L 5/00; H04L 27/26; H04W 72/51

(52) U.S. Cl. CPC H04W 56/001; H04L 5/0035; H04L 27/2662; H04W 72/51

(57) ABSTRACT

Apparatuses, methods, and systems are disclosed for dual connectivity enhancements in integrated access and backhaul. An apparatus (1300) includes a transceiver (1325) that receives a first attribute associated with a first symbol on a first cell, receives a second attribute associated with a second symbol on a second cell, and receives first information of a first timing alignment 5 for the first cell and second information of a second timing alignment for the second cell. The apparatus (1300) includes a processor (1305) that determines which of the first cell and the second cell is a reference cell based on the first and second information and, in response to determining that the first cell is the reference cell, neglects a second operation associated with the second symbol, and in response to determining that the second cell is the reference cell, neglects a first 0 operation associated with the first symbol.

### CROSS-REFERENCE TO RELATED APPLICATIONS

This application claims priority to U.S. Provisional Patent Application No. 63/186,727 entitled “APPARATUSES, METHODS, AND SYSTEMS FOR DUAL CONNECTIVITY ENHANCEMENTS IN INTEGRATED ACCESS AND BACKHAUL” and filed on May 10, 2021, for Majid Ghanbarinejad, et al., which is incorporated herein by reference.

### FIELD

The subject matter disclosed herein relates generally to wireless communications and more particularly relates to dual connectivity enhancements in integrated access and backhaul.

### BACKGROUND

In wireless networks, integrated access and backhaul (“IAB”) was specified for new radio access technology (“NR”) Release 16 (Rel-16). The IAB technology aims at increasing deployment flexibility and reducing 5G rollout costs. It allows service providers to reduce cell planning and spectrum planning efforts while utilizing the wireless backhaul technology.

### BRIEF SUMMARY

Disclosed are solutions for dual connectivity enhancements in integrated access and backhaul. The solutions may be implemented by apparatus, systems, methods, or computer program products.

In one embodiment, a first apparatus includes a transceiver that receives a first attribute associated with a first symbol on a first cell, the first attribute comprising a first downlink or a first uplink value, receives a second attribute associated with a second symbol on a second cell, the second attribute comprising a second downlink or a second uplink value, the second symbol overlapping with the first symbol in a time domain, and receives first information of a first timing alignment for the first cell and second information of a second timing alignment for the second cell. In one embodiment, the first apparatus includes a processor that determines which of the first cell and the second cell is a reference cell based on the first information of the first timing alignment and the second information of the second timing alignment, and in response to determining that the first cell is the reference cell, neglects a second operation associated with the second symbol, and in response to determining that the second cell is the reference cell, neglects a first operation associated with the first symbol.

In one embodiment, a first method receives a first attribute associated with a first symbol on a first cell, the first attribute comprising a first downlink or a first uplink value, receives a second attribute associated with a second symbol on a second cell, the second attribute comprising a second downlink or a second uplink value, the second symbol overlapping with the first symbol in a time domain, and receives first information of a first timing alignment for the first cell and second information of a second timing alignment for the second cell. In one embodiment, the first method determines which of the first cell and the second cell is a reference cell based on the first information of the first timing alignment and the second information of the second timing alignment, and in response to determining that the first cell is the reference cell, neglects a second operation associated with the second symbol, and in response to determining that the second cell is the reference cell, neglects a first operation associated with the first symbol.

In one embodiment, a second apparatus includes a transceiver that receives a configuration of a first signal, a first direction of the first signal being different than a second direction of a second signal and receives a control message at a first time, the control message being associated with the first signal. In one embodiment, the second apparatus includes a processor that determines a time threshold, and in response to determining that the first time is not later than the time threshold, considers the first signal as a configured signal, and in response to determining that the first time is later than the time threshold, considers the first signal as a dynamic signal.

In one embodiment, a second method receives a configuration of a first signal, a first direction of the first signal being different than a second direction of a second signal and receives a control message at a first time, the control message being associated with the first signal. In one embodiment, the second method determines a time threshold, and in response to determining that the first time is not later than the time threshold, considers the first signal as a configured signal, and in response to determining that the first time is later than the time threshold, considers the first signal as a dynamic signal.

In one embodiment, a third apparatus includes a transceiver that receives a first attribute associated with a first symbol on a first cell, the first attribute comprising a first downlink or a first uplink value and receives a second attribute associated with a second symbol on a second cell, the second attribute comprising a second downlink or a second uplink value, the second symbol overlapping with the first symbol in a time domain. In one embodiment, the third apparatus includes a processor that determines which of the first cell and the second cell is a reference cell, and in response to determining that the first cell is the reference cell, neglects a second operation associated with the second symbol, and in response to determining that the second cell is the reference cell, neglects a first operation associated with the first symbol.

In one embodiment, a third method receives a first attribute associated with a first symbol on a first cell, the first attribute comprising a first downlink or a first uplink value and receives a second attribute associated with a second symbol on a second cell, the second attribute comprising a second downlink or a second uplink value, the second symbol overlapping with the first symbol in a time domain. In one embodiment, the third method determines which of the first cell and the second cell is a reference cell, and in response to determining that the first cell is the reference cell, neglects a second operation associated with the second symbol, and in response to determining that the second cell is the reference cell, neglects a first operation associated with the first symbol.

In one embodiment, a fourth apparatus includes a transceiver that receives a first attribute associated with a first symbol for a first mobile terminal (“MT”) functionality, the first attribute comprising a first downlink or a first uplink value and receives a second attribute associated with a second symbol for a second MT functionality, the second attribute comprising a second downlink or a second uplink value, the second symbol overlapping with the first symbol in a time domain. In one embodiment, the fourth apparatus includes a processor that determines which of the first MT and the second MT is a reference MT, and in response to determining that the first MT is the reference MT, neglects a second operation associated with the second symbol, and in response to determining that the second MT is the reference MT, neglects a first operation associated with the first symbol.

In one embodiment, a fourth method receives a first attribute associated with a first symbol for a first mobile terminal (“MT”) functionality, the first attribute comprising a first downlink or a first uplink value and receives a second attribute associated with a second symbol for a second MT functionality, the second attribute comprising a second downlink or a second uplink value, the second symbol overlapping with the first symbol in a time domain. In one embodiment, the fourth method determines which of the first MT and the second MT is a reference MT, and in response to determining that the first MT is the reference MT, neglects a second operation associated with the second symbol, and in response to determining that the second MT is the reference MT, neglects a first operation associated with the first symbol.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for dual connectivity enhancements in integrated access and backhaul:

FIG. 2A is an illustration of one embodiment of an example of an integrated access and backhaul (IAB) system for dual connectivity enhancements in integrated access and backhaul:

FIG. 2B is an illustration of one embodiment of the CU/DU split in an IAB donor, and the DU/MT split in IAB nodes for dual connectivity enhancements in integrated access and backhaul:

FIG. 3 is an illustration of an example IAB system with single-panel and multi-panel IAB nodes for dual connectivity enhancements in integrated access and backhaul;

FIG. 4 is an illustration of scenarios of simultaneous transmission and/or reception operations as agreed in RAN1#102-e for dual connectivity enhancements in integrated access and backhaul:

FIG. 5 depicts example code for supporting half duplex operations and for enabling directional collision handling:

FIG. 6 is an illustration of a DC architecture with one IAB-CU/IAB donor (intra-donor scenario) for dual connectivity enhancements in integrated access and backhaul:

FIG. 7 is an illustration of a DC architecture with multiple IAB-CUs/IAB donors (inter-donor scenario) for dual connectivity enhancements in integrated access and backhaul:

FIG. 8 is an illustration of alternative scenarios for enhanced resource multiplexing and simultaneous operations for dual connectivity enhancements in integrated access and backhaul:

FIG. 9 is an illustration of time threshold specified/configured for conflict resolution for dual connectivity enhancements in integrated access and backhaul:

FIG. 10 is an illustration of time threshold specified/configured for conflict resolution according to an alternative description for dual connectivity enhancements in integrated access and backhaul:

FIG. 11 is an illustration of an IAB node connected to two or multiple parent nodes in the upstream direction and two or multiple child nodes or UEs in the downstream direction for dual connectivity enhancements in integrated access and backhaul:

FIG. 12 is a diagram illustrating one embodiment of a NR protocol stack:

FIG. 13 is a block diagram illustrating one embodiment of a user equipment apparatus that may be used for dual connectivity enhancements in integrated access and backhaul;

FIG. 14 is a block diagram illustrating one embodiment of a network apparatus that may be used for dual connectivity enhancements in integrated access and backhaul:

FIG. 15 is a flowchart diagram illustrating one embodiment of a method for dual connectivity enhancements in integrated access and backhaul:

FIG. 16 is a flowchart diagram illustrating one embodiment of a method for dual connectivity enhancements in integrated access and backhaul:

FIG. 17 is a flowchart diagram illustrating one embodiment of a method for dual connectivity enhancements in integrated access and backhaul; and

FIG. 18 is a flowchart diagram illustrating one embodiment of a method for dual connectivity enhancements in integrated access and backhaul.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including.” “comprising,” “having.” and variations thereof mean “including but not limited to,” unless expressly specified otherwise. An enumerated listing of items does not imply that any or all of the items are mutually exclusive, unless expressly specified otherwise. The terms “a.” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatuses for dual connectivity enhancements in integrated access and backhaul. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

IAB was specified for NR access technology Release 16 (Rel-16). The IAB technology aims at increasing deployment flexibility and reducing 5G rollout costs. It allows service providers to reduce cell planning and spectrum planning efforts while utilizing the wireless backhaul technology.

Although the IAB specification in Rel-16 is not limited to a specific multiplexing and duplexing scheme, the focus is on time-division multiplexing (“TDM”) between upstream communications (with a parent IAB node or IAB donor) and downstream communications (with a child IAB node or a user equipment (“UE”)).

It was approved for the 3GPP Rel-17 to enhance resource multiplexing for supporting simultaneous operations (transmissions and/or receptions) in downstream and upstream by an IAB node, as listed in the following objectives:
Duplexing enhancements (e.g., as discussed in RAN1-led, RAN2, RAN3, RAN4):
   Specification of enhancements to the resource multiplexing between child and parent links of an IAB node, including:
      Support of simultaneous operation (transmission and/or reception) of IAB-node's child and parent links (e.g., MT Tx/DU Tx, MT Tx/DU Rx, MT Rx/DU Tx, MT Rx/DU Rx).
      Support for dual-connectivity scenarios defined by RAN2/RAN3 in the context of topology redundancy for improved robustness and load balancing.
   Specification of IAB-node timing mode(s), extensions for DL/UL power control, and CLI and interference measurements of BH links, as needed, to support simultaneous operation (transmission and/or reception) by IAB-node's child and parent links.

As highlighted in the above objectives, dual connectivity (“DC”) is to be enhanced in order to provide topology redundancy for improving robustness and load balancing.

Discussions on DC enhancements have been discussed in RAN1 and other groups. For example, the following was agreed in RAN1 #104bis-e:
The following enhancements to support intra-band inter-carrier dual connectivity for both inter-donor and intra-donor scenarios are considered (in addition to reusing solutions for inter-band dual connectivity) to support simultaneous Tx and/or Rx at the child IAB-MT to/from both parent links:
   Extending the Rel-16 CA TDD conflict resolution framework for synchronous intra-band NR-DC operation
   Coordinating TDD configurations for the parent nodes (for both intra-donor and inter-donor operation) and coordinating H/S/NA configurations for the child node between donors (at least for inter-donor operation).

The enhanced IAB work item (“WI”) includes enhancements to DC in the context of topology enhancements for improving robustness and load balancing. Two of the issues being discussed are methods of conflict resolution for intra-band NR-DC operation, by extending an existing conflict resolution that was specified as a Rel-16 TEI, as well as coordinating TDD configurations for intra-donor and inter-donor operation. The existing specification on the former matter is applicable to UEs and, hence, does not address IAB-specific matters such as timing misalignment, interference constraints, availability indication for soft resources, and so on.

The existing solutions for CA TDD collision handling, primarily specified for UE operation, does not include the case of timing misalignment due to applying an enhanced timing alignment for IAB. However, in an enhanced IAB system, timing alignment modes such as Case-6 and Case-7 timing modes applied to uplink transmission may violate the assumption of synchronicity, and furthermore, may need to be considered for determining the “reference cell” in the case of a TDD conflict resolution when the parent nodes are not TDD-coordinated.

In the present disclosure, the above matters are discussed and addressed. In particular, methods for conflict resolutions for DC operation are introduced and extended for different scenarios. Inter-parent and inter-donor coordination signaling are also discussed and addressed.

The methods proposed in this disclosure include several additional steps and rules for determining a “reference cell” and an “other cell” prior to applying conflict resolution rules such as dropping a DL/UL attribute on the other cell, overriding a DL/UL attribute on the reference cell, or determining an error case. The impact of availability indication on parent node behavior is also considered. Furthermore, priority rules for cases that a DL/UL conflict does not occur, but beam/power/interference/timing constraints limit simultaneous operation are extended to the case of intra-band DC.

In one embodiment, a cell performing a TX timing alignment (Case-6 described below) is determined a reference cell for conflict resolution. Then, DL/UL conflicts are resolved among symbols, which may overlap fully or partially, by applying conflict resolution rules. In another embodiment, when a parent node transmits an availability indication for a soft resource configured for a child node, it may expect an error case on a time-overlapping resource. In yet another embodiment, a symbol DL/UL attribute may be dropped or overridden if beam/power/interference constraint is not satisfied.

In the following descriptions, the terms antenna, panel, antenna panel, device panel and UE panel are used interchangeably. An antenna panel may be a hardware that is used for transmitting and/or receiving radio signals at frequencies lower than 6 GHz, e.g., frequency range 1 (“FR1”, i.e., frequencies from 410 MHz to 7125 MHZ), or higher than 6 GHz, e.g., frequency range 2 (“FR2”, i.e., frequencies from 24.25 GHz to 52.6 GHz) or millimeter wave (mmWave). In some embodiments, an antenna panel may comprise an array of antenna elements, wherein each antenna element is connected to hardware such as a phase shifter that allows a control module to apply spatial parameters for transmission and/or reception of signals. The resulting radiation pattern may be called a beam, which may or may not be unimodal and may allow the device to amplify signals that are transmitted or received from spatial directions.

In some embodiments, an antenna panel may or may not be virtualized as an antenna port in the specifications. An antenna panel may be connected to a baseband processing module through a radio frequency (“RF”) chain for each of transmission (egress) and reception (ingress) directions. A capability of a device in terms of the number of antenna panels, their duplexing capabilities, their beamforming capabilities, and so on, may or may not be transparent to other devices. In some embodiments, capability information may be communicated via signaling or, in some embodiments, capability information may be provided to devices without a need for signaling. In the case that such information is available to other devices, it can be used for signaling or local decision making.

In some embodiments, a device antenna panel (e.g., of a UE or RAN node) may be a physical or logical antenna array comprising a set of antenna elements or antenna ports that share a common or a significant portion of an RF chain (e.g., in-phase/quadrature (“I/Q”) modulator, analog-to-digital (“A/D”) converter, local oscillator, phase shift network). The device antenna panel or “device panel” may be a logical entity with physical device antennas mapped to the logical entity. The mapping of physical device antennas to the logical entity may be up to device implementation. Communicating (receiving or transmitting) on at least a subset of antenna elements or antenna ports active for radiating energy (also referred to herein as active elements) of an antenna panel requires biasing or powering on of the RF chain which results in current drain or power consumption in the device associated with the antenna panel (including power amplifier/low noise amplifier (“LNA”) power consumption associated with the antenna elements or antenna ports). The phrase “active for radiating energy.” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In some embodiments, depending on device's own implementation, a “device panel” can have at least one of the following functionalities as an operational role of Unit of antenna group to control its Tx beam independently, Unit of antenna group to control its transmission power independently, Unit of antenna group to control its transmission timing independently. The “device panel” may be transparent to gNB. For certain condition(s), gNB or network can assume the mapping between device's physical antennas to the logical entity “device panel” may not be changed. For example, the condition may include until the next update or report from device or comprise a duration of time over which the gNB assumes there will be no change to the mapping.

A device may report its capability with respect to the “device panel” to the gNB or network. The device capability may include at least the number of “device panels.” In one implementation, the device may support UL transmission from one beam within a panel; with multiple panels, more than one beam (one beam per panel) may be used for UL transmission. In another implementation, more than one beam per panel may be supported/used for UL transmission.

In some of the embodiments described, an antenna port is defined such that the channel over which a symbol on the antenna port is conveyed can be inferred from the channel over which another symbol on the same antenna port is conveyed. Two antenna ports are said to be quasi co-located (QCL) if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters. Two antenna ports may be quasi-located with respect to a subset of the large-scale properties and different subset of large-scale properties may be indicated by a QCL Type. For example, qcl-Type may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}.

Spatial Rx parameters may include one or more of: angle of arrival (AoA), Dominant AoA, average AoA, angular spread, Power Angular Spectrum (PAS) of AoA, average AoD (angle of departure), PAS of AoD, transmit/receive channel correlation, transmit/receive beamforming, spatial channel correlation, etc.

An “antenna port” according to an embodiment may be a logical port that may correspond to a beam (resulting from beamforming) or may correspond to a physical antenna on a device. In some embodiments, a physical antenna may map directly to a single antenna port, in which an antenna port corresponds to an actual physical antenna. Alternately, a set or subset of physical antennas, or antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (“CDD”). The procedure used to derive antenna ports from physical antennas may be specific to a device implementation and transparent to other devices.

In some of the embodiments described, a TCI-state associated with a target transmission can indicate parameters for configuring a quasi-collocation relationship between the target transmission (e.g., target RS of DM-RS ports of the target transmission during a transmission occasion) and a source reference signal(s) (e.g., SSB/CSI-RS/SRS) with respect to quasi co-location type parameter(s) indicated in the corresponding TCI state. A device can receive a configuration of a plurality of transmission configuration indicator states for a serving cell for transmissions on the serving cell.

In some of the embodiments described, a spatial relation information associated with a target transmission can indicate parameters for configuring a spatial setting between the target transmission and a reference RS (e.g., SSB/CSI-RS/SRS). For example, the device may transmit the target transmission with the same spatial domain filter used for reception the reference RS (e.g., DL RS such as SSB/CSI-RS). In another example, the device may transmit the target transmission with the same spatial domain transmission filter used for the transmission of the reference RS (e.g., UL RS such as SRS). A device can receive a configuration of a plurality of spatial relation information configurations for a serving cell for transmissions on the serving cell.

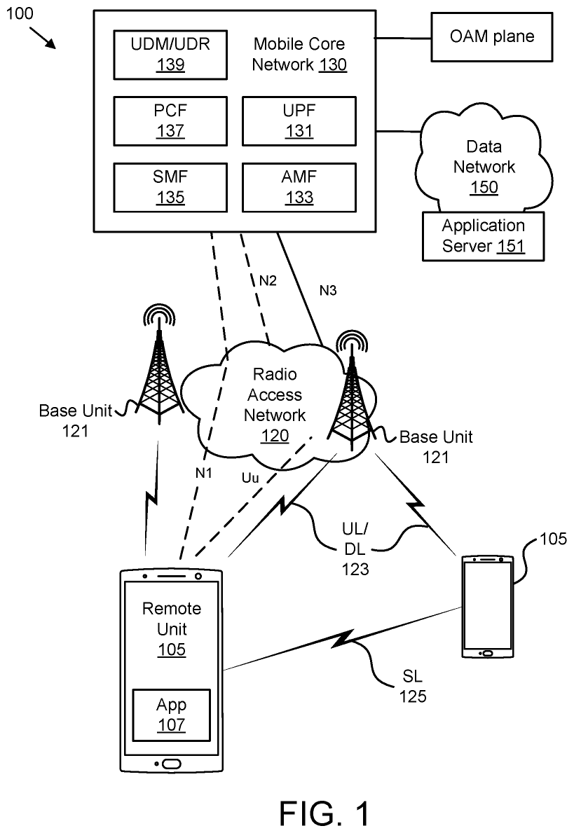

FIG. 1 depicts a wireless communication system 100 supporting CSI enhancements for higher frequencies, according to embodiments of the disclosure. In one embodiment, the wireless communication system 100 includes at least one remote unit 105, a radio access network (“RAN”) 120, and a mobile core network 130. The RAN 120 and the mobile core network 130 form a mobile communication network. The RAN 120 may be composed of a base unit 121 with which the remote unit 105 communicates using wireless communication links 115. Even though a specific number of remote units 105, base units 121, wireless communication links 115, RANs 120, and mobile core networks 130 are depicted in FIG. 1, one of skill in the art will recognize that any number of remote units 105, base units 121, wireless communication links 115, RANs 120, and mobile core networks 130 may be included in the wireless communication system 100.

In one implementation, the RAN 120 is compliant with the 5G system specified in the Third Generation Partnership Project (“3GPP”) specifications. For example, the RAN 120 may be a New Generation Radio Access Network (“NG-RAN”), implementing NR RAT and/or 3GPP Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. Furthermore, the UL and DL communication signals may be carried over the wireless communication links 123. Here, the RAN 120 is an intermediate network that provides the remote units 105 with access to the mobile core network 130.

In some embodiments, the remote units 105 communicate with an application server via a network connection with the mobile core network 130. For example, an application 107 (e.g., web browser, media client, telephone and/or Voice-over-Internet-Protocol (“VOIP”) application) in a remote unit 105 may trigger the remote unit 105 to establish a protocol data unit (“PDU”) session (or other data connection) with the mobile core network 130 via the RAN 120. The mobile core network 130 then relays traffic between the remote unit 105 and the application server (e.g., the content server 151 in the packet data network 150) using the PDU session. The PDU session represents a logical connection between the remote unit 105 and the User Plane Function (“UPF”) 131.

In order to establish the PDU session (or PDN connection), the remote unit 105 must be registered with the mobile core network 130 (also referred to as “attached to the mobile core network” in the context of a Fourth Generation (“4G”) system). Note that the remote unit 105 may establish one or more PDU sessions (or other data connections) with the mobile core network 130. As such, the remote unit 105 may have at least one PDU session for communicating with the packet data network 150, e.g., representative of the Internet. The remote unit 105 may establish additional PDU sessions for communicating with other data networks and/or other communication peers.

In the context of a 5G system (“5GS”), the term “PDU Session” a data connection that provides end-to-end (“E2E”) user plane (“UP”) connectivity between the remote unit 105 and a specific Data Network (“DN”) through the UPF 131. A PDU Session supports one or more Quality of Service (“QoS”) Flows. In certain embodiments, there may be a one-to-one mapping between a QoS Flow and a QoS profile, such that all packets belonging to a specific QOS Flow have the same 5G QOS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 130. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 130 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR-U operation, the base unit 121 and the remote unit 105 communicate over unlicensed radio spectrum.

In one embodiment, the mobile core network 130 is a 5GC or an Evolved Packet Core (“EPC”), which may be coupled to a packet data network 150, like the Internet and private data networks, among other data networks. A remote unit 105 may have a subscription or other account with the mobile core network 130. Each mobile core network 130 belongs to a single public land mobile network (“PLMN”). The present disclosure is not intended to be limited to the implementation of any particular wireless communication system architecture or protocol.

The mobile core network 130 includes several network functions (“NFs”). As depicted, the mobile core network 130 includes at least one UPF 131. The mobile core network 130 also includes multiple control plane (“CP”) functions including, but not limited to, an Access and Mobility Management Function (“AMF”) 133 that serves the RAN 120, a Session Management Function (“SMF”) 135, a Network Exposure Function (“NEF”) 136, a Policy Control Function (“PCF”) 137, a Unified Data Management function (“UDM”) and a User Data Repository (“UDR”).

The UPF(s) 131 is responsible for packet routing and forwarding, packet inspection, QoS handling, and external PDU session for interconnecting Data Network (“DN”), in the 5G architecture. The AMF 133 is responsible for termination of NAS signaling, NAS ciphering & integrity protection, registration management, connection management, mobility management, access authentication and authorization, security context management. The SMF 135 is responsible for session management (i.e., session establishment, modification, release), remote unit (i.e., UE) IP address allocation & management, DL data notification, and traffic steering configuration for UPF for proper traffic routing.

The NEF 136 is responsible for making network data and resources easily accessible to customers and network partners. Service providers may activate new capabilities and expose them through APIs. These APIs allow third-party authorized applications to monitor and configure the network's behavior for a number of different subscribers (i.e., connected devices with different applications). The PCF 137 is responsible for unified policy framework, providing policy rules to CP functions, access subscription information for policy decisions in UDR.

The UDM is responsible for generation of Authentication and Key Agreement (“AKA”) credentials, user identification handling, access authorization, subscription management. The UDR is a repository of subscriber information and can be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 139.

In various embodiments, the mobile core network 130 may also include an Authentication Server Function (“AUSF”) (which acts as an authentication server), a Network Repository Function (“NRF”) (which provides NF service registration and discovery, enabling NFs to identify appropriate services in one another and communicate with each other over Application Programming Interfaces (“APIs”)), or other NFs defined for the 5GC. In certain embodiments, the mobile core network 130 may include an authentication, authorization, and accounting (“AAA”) server.

In various embodiments, the mobile core network 130 supports different types of mobile data connections and different types of network slices, wherein each mobile data connection utilizes a specific network slice. Here, a “network slice” refers to a portion of the mobile core network 130 optimized for a certain traffic type or communication service. A network instance may be identified by a single-network slice selection assistance information (“S-NSSAI,”) while a set of network slices for which the remote unit 105 is authorized to use is identified by network slice selection assistance information (“NSSAI”).

Here, “NSSAI” refers to a vector value including one or more S-NSSAI values. In certain embodiments, the various network slices may include separate instances of network functions, such as the SMF 135 and UPF 131. In some embodiments, the different network slices may share some common network functions, such as the AMF 133. The different network slices are not shown in FIG. 1 for ease of illustration, but their support is assumed. Where different network slices are deployed, the mobile core network 130 may include a Network Slice Selection Function (“NSSF”) which is responsible for selecting of the Network Slice instances to serve the remote unit 105, determining the allowed NSSAI, determining the AMF set to be used to serve the remote unit 105.

Although specific numbers and types of network functions are depicted in FIG. 1, one of skill in the art will recognize that any number and type of network functions may be included in the mobile core network 130. Moreover, in an LTE variant where the mobile core network 130 comprises an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 133 may be mapped to an MME, the SMF 135 may be mapped to a control plane portion of a PGW and/or to an MME, the UPF 131 may be mapped to an SGW and a user plane portion of the PGW, the UDM/UDR 139 may be mapped to an HSS, etc.

The Operations, Administration and Maintenance (“OAM”) 160 is involved with the operating, administering, managing and maintaining of the system 100. “Operations” encompass automatic monitoring of environment, detecting and determining faults and alerting admins. “Administration” involves collecting performance stats, accounting data for the purpose of billing, capacity planning using Usage data and maintaining system reliability. Administration can also involve maintaining the service databases which are used to determine periodic billing. “Maintenance” involves upgrades, fixes, new feature enablement, backup and restore and monitoring the media health. In certain embodiments, the OAM 160 may also be involved with provisioning. i.e., the setting up of the user accounts, devices and services.

While FIG. 1 depicts components of a 5G RAN and a 5G core network, the described embodiments apply to other types of communication networks and RATs, including IEEE 802.11 variants, Global System for Mobile Communications (“GSM”, i.e., a 2G digital cellular network), General Packet Radio Service (“GPRS”), UMTS, LTE variants, CDMA 2000, Bluetooth, ZigBee, Sigfox, and the like.

In the following descriptions, the term “gNB” is used for the base station but it is replaceable by any other radio access node, e.g., RAN node, eNB, Base Station (“BS”), Access Point (“AP”), NR, etc. Further the operations are described mainly in the context of 5G NR. However, the proposed solutions/methods are also equally applicable to other mobile communication systems supporting dual connectivity enhancements in integrated access and backhaul.

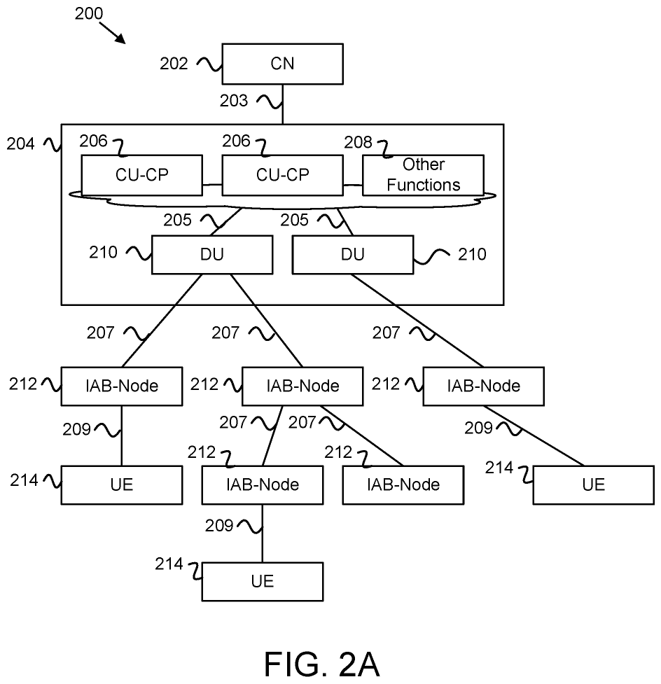

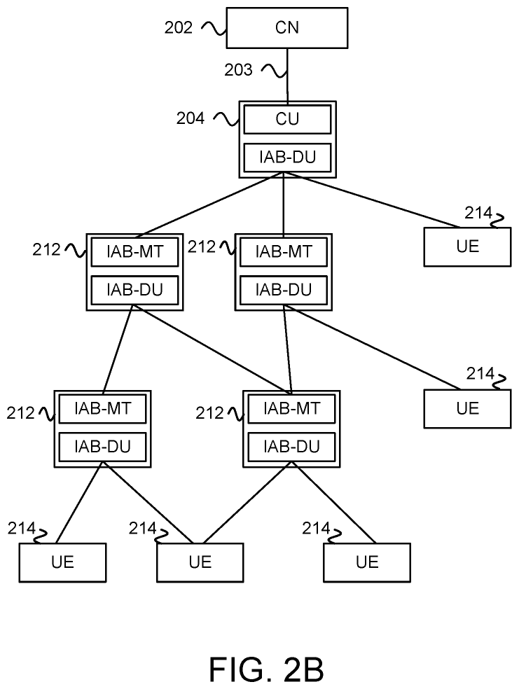

Regarding integrated access and backhaul, as background, FIG. 2A illustrates an example of an integrated access and backhaul (IAB) system 200. The core network 202 is connected to an IAB donor 204 of an IAB system 200 through a backhaul link 203, which is typically wired. The IAB donor 204 comprises a central unit (“CU”) 206 that communicates with all the distributed units (“DUs”) 210 in the system through an F1 interface 205. The IAB donor 204 is a single logical node that may comprise a set of functions 208 such as gNB-DU, gNB-CU-CP, gNB-CU-UP, and so on. In a deployment, the IAB donor 204 can be split according to these functions, which can all be either collocated or non-collocated.

Each IAB node 212 is functionally split into at least a distributed unit (“DU”) and a mobile terminal (“MT”). An MT of an IAB node 212 is connected to a DU 210 of a parent node, which may be another IAB node 212 or an IAB donor 204.

A Uu link between an MT of an IAB node 212 (called an IAB-MT) and a DU 210 of a parent node (called an IAB-DU) is called a wireless backhaul link 207. In the wireless backhaul link 207, in terms of functionalities, the MT is similar to user equipment (“UE”) 214 and the DU 210 of the parent node is similar to a base station in a conventional cellular wireless access link. Therefore, a link from an MT to a serving cell that is a DU 210 of a parent link is called an uplink, and a link in the reverse direction is called a downlink. For the sake of brevity, in the rest of this disclosure, embodiments may simply refer to an uplink or a downlink between IAB nodes 212, an upstream link or a downstream link of an IAB node 212, a link between a node and its parent node, a link between a node and its child node, and so on without a direct reference to an IAB-MT, IAB-DU, serving cell, and so on.

Each IAB donor 204 or IAB node 212 may serve UEs 214 through access links 209. IAB systems 200 are designed to allow multi-hop communications, e.g., a UE 214 may be connected to the core network 202 through an access link 209 and multiple backhaul links 207 between IAB nodes 212 and an IAB donor 204. For the rest of this disclosure, unless stated otherwise, an “IAB node” may generally refer to an IAB node 212 or an IAB donor 204.

FIG. 2B is a block diagram illustrating one embodiment of a summary of a CU/DU split in an IAB donor 204 and a DU/MT split in IAB nodes 212. FIG. 2B illustrates the functional splits of an IAB donor 204 and IAB nodes 212. In this figure, an IAB node 212 or a UE 214 can be served by more than one serving cell as they support dual connectivity (“DC”).

A node, link, or the like, closer to the IAB donor 204 and/or the core network 202 is called an upstream node or link. For example, a parent node of a subject node is an upstream node of the subject node and the link to the parent node is an upstream link with respect to the subject node. Similarly, a node or link farther from the IAB donor 204 and/or the core network 202 is called a downstream node or link. For example, a child node of a subject node is a downstream node of the subject node and the link to the child node is a downstream link with 10 respect to the subject node.

The following table summarizes the terminology used in this disclosure for the sake of brevity versus the description that may appear in the standard specifications.

| Phrase | Description |
|---|---|
| Wireless backhaul link | A connection between an MT of an IAB node and a DU of a |
| | serving cell |
| Wireless access link | A connection between a UE and (a DU of) a serving cell |
| IAB-node/IAB node | RAN node that supports NR access links to UEs and NR |
| | backhaul links to parent nodes and child nodes |
| IAB-MT | IAB-node function that terminates the Uu interface to the |
| | parent node |
| IAB-DU | gNB-DU functionality supported by the IAB-node to |
| | terminate the NR access interface to UEs and next-hop IAB- |
| | nodes, and to terminate the F1 protocol to the gNB-CU |
| | functionality on the IAB-donor |
| IAB-donor/IAB donor | gNB that provides network access to UEs via a network of |
| | backhaul and access links |
| Parent [IAB] node | An IAB node or IAB donor that comprises a serving cell of |
| | the subject node. In some examples, IAB-MT's next hop |
| | neighbour node; the parent node may be an IAB-DU of an |
| | IAB-node or an IAB-donor. |
| Child [IAB] node | An IAB node that identifies the subject node as a serving |
| | cell. In some examples, IAB-DU's next hop neighbour node; |
| | the child node is also an IAB-node. In some embodiments, a |
| | UE or an enhanced UE or an IAB-enhanced UE may perform |
| | similarly to a child IAB node. |
| Sibling [IAB] node | An IAB node that has a common parent with the subject |
| | node |
| Uplink (of a wireless backhaul | A link from an MT to a DU of a parent node |
| link) | |
| Downlink (of a wireless | A link from a DU to an MT of a child node |
| backhaul link) | |
| Upstream node/link/etc. | A node/link/etc. (topologically) closer to the IAB donor/ |
| | core network. Direction toward a parent node in an IAB |
| | topology. |
| Downstream node/link/etc. | A node/link/etc. (topologically) farther from the IAB donor/ |
| | core network. Direction toward a child node or UE in an IAB |
| | topology. |

Furthermore, an “operation” or a “communication,” where appropriate, may refer to a transmission or a reception in an uplink (or upstream) or a downlink (or downstream). Then, the terms “simultaneous operation” or “simultaneous communications” may refer to multiplexing/duplexing transmissions and/or receptions by a node through one or multiple antennas/panels. Details of the simultaneous operation, if not described explicitly, should be understood from the context.

Regarding resource configuration in NR IAB Rel-16, as mentioned previously, more slot formats are introduced in NR IAB Rel-16 to allow higher flexibility.

Furthermore, resources can be configured as hard (“H”), soft (“S”), or not available (“NA”). Hard resources can be assumed available for scheduling by the IAB node and NA resources cannot be assumed available, while soft resources can be indicated available or not available dynamically. Dynamic availability indication (“AI”) for soft resources can be performed by DCI format 2_5 from a parent IAB node/donor and has similarities in formats and definitions with SFI (DCI format 2_0).

In one embodiment, resources can be shared between backhaul and access links, which can be configured semi-statically by the CU (IAB donor at layer-3) or dynamically by DU (parent IAB node at layer-1). Multiplexing between backhaul link and access link resources can be TDM, frequency division multiplexed (“FDM”), or allow time-frequency resource sharing. Furthermore, resources can be allocated exactly (per node or per link) or in the form of a resource pool. Nokia had a mention of a resource pool approach as well.

There were proposals to allow semi-static configuration at layer-2 or layer-3 for sharing resources between backhaul and access. It should be noted that in this TDoc and the previously mentioned TDocs, the emphasis is on configuration of resources for backhaul vs. access rather than upstream vs. downstream. However, under dynamic scheduling, this TDoc does briefly suggest that an IAB node can use the resources not used by the parent IAB node for backhaul to schedule the access link.

Semi-static vs. dynamic resource coordination approaches may be implemented, including “flexible partitioning” of resources in time and frequency domains. For example, ‘F’ (flexible) in DCI 2_0 and a new state ‘A’ (access) for determining slot format and sharing resources with the access link may be used. This may be similar to the use of hard and soft configurations and availability indication in IAB Rel-16.

In some embodiments, there is a distinction between “inter-panel” from “intra-panel” FDM and SDM. Power limitations and timing requirements are briefly mentioned for each case.

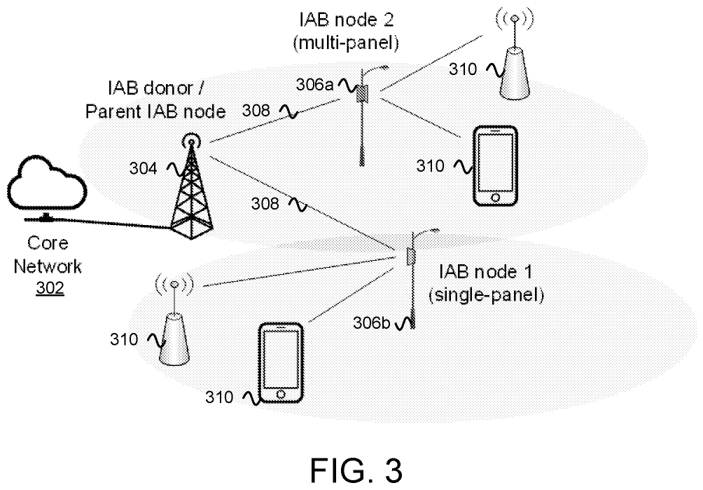

In general, an IAB system is connected to a core network 302 through one or multiple IAB donors 304. Each IAB node 306 may be connected to an IAB donor 304 and/or other IAB nodes 306 through wireless backhaul links 308. Each IAB donor/node 304 may also serve UEs 310. Consider the example IAB system illustrated in FIG. 3.

There are various options with regards to the structure and multiplexing/duplexing capabilities of an IAB node 306. For example, each IAB node 306 may have one 306a or multiple 306b antenna panels, each connected to the baseband unit through an RF chain. The one or multiple antenna panels may be able to serve a wide spatial area of interest in a vicinity of the IAB node 306, or otherwise each antenna panel or each group of antenna panels may provide a partial coverage such as a “sector.” An IAB node with multiple antenna panels 306a, each serving a separate spatial area or sector, may still be referred to as a single-panel IAB node 306b as it behaves similarly to a single-panel IAB node 306b for communications in each of the separate spatial areas or sectors.

Furthermore, each antenna panel may be half-duplex (“HD”), meaning that it is able to either transmit or receive signals in a frequency band at a time, or full-duplex (“FD”), meaning that it is able to both transmit and receive signals in a frequency band simultaneously. Unlike full-duplex radio, half-duplex radio is widely implemented and used in practice and is usually assumed as the default mode of operation in wireless systems.

The following table lists different duplexing scenarios of interest when multiplexing is not constrained to TDM. In this table, single-panel and multi-panel IAB nodes are considered for different cases of simultaneous transmission and/or reception. Spatial-division multiplexing (“SDM”) refers to either transmission or reception on downlink (or downstream) and uplink (or upstream) simultaneously; full duplex (“FD”) refers to simultaneous transmission and reception by a same antenna panel in a frequency band; and multi-panel transmission and reception (“MPTR”) refers to simultaneous transmission and/or reception by multiple antenna panels where each antenna panel either transmits or receives in a frequency band at a time.

| | Architecture/ | Simultaneous | | | Sce- |
|---|---|---|---|---|---|
| Case# | Capability | TX/RX Type | IAB-MT | IAB-DU | nario# |
| Case A/ | Single-panel | TX SDM | UL-TX | DL-TX | S3 |
| Case#1 | Multi-panel | TX | UL-TX | DL-TX | S7 |
| | | MPTR/SDM | | | |
| Case B/ | Single-panel | RX SDM | DL-RX | UL-RX | S1 |
| Case#2 | Multi-panel | RX | DL-RX | UL-RX | S5 |
| | | MPTR/SDM | | | |
| Case C/ | Single-panel | UL FD | UL-TX | UL-RX | S4 |
| Case#3 | Multi-panel | UL | UL-TX | UL-RX | S8 |
| | | MPTR/FD | | | |
| Case D/ | Single-panel | DL FD | DL-RX | DL-TX | S2 |
| Case#4 | Multi-panel | DL | DL-RX | DL-TX | S6 |
| | | MPTR/FD | | | |

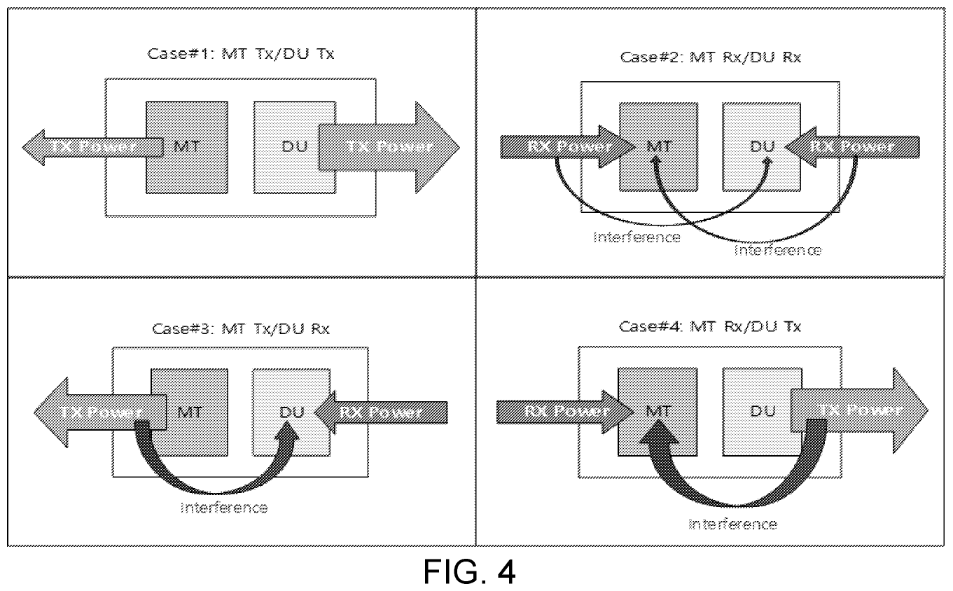

In the above table, based on the type of simultaneous operations and the number of panels in an IAB node, the scenarios are called S1, S2, . . . , S8 in accordance with our previous disclosures, while the “Case” numbers (A/B/C/D or 1/2/3/4) are in accordance with the RAN1 #102-e agreements in the Chairman's Notes, as illustrated in FIG. 4.

In this disclosure, scenarios may be referred to by their Case # or Scenario # according to the presented table.

Regarding Rel-16 TEI for collision handling in half-duplex CA TDD, in one embodiment, a slot format includes downlink symbols, uplink symbols, and flexible symbols.

If a UE is configured with multiple serving cells and is provided half-duplex-behavior=‘enable’, is not capable of simultaneous transmission and reception on any of the multiple serving cells, indicates support of capability for half-duplex operation in CA with unpaired spectrum, and is not configured to monitor PDCCH for detection of DCI format 2_0 on any of the multiple serving cells, for a set of symbols of a slot that are indicated to the UE for reception of SS/PBCH blocks in any of multiple serving cells by ssb-PositionsInBurst in SystemInformationBlockType1 or by ssb-PositionsInBurst in ServingCellConfigCommon, when provided to the UE, the UE does not transmit PUSCH, PUCCH, or PRACH in the slot if a transmission would overlap with any symbol from the set of symbols, and the UE does not transmit SRS in the set of symbols of the slot in any of multiple serving cells.

For a set of symbols of a slot corresponding to a valid PRACH occasion and symbols before the valid PRACH occasion, as described in Clause 8.1, the UE does not receive PDCCH, PDSCH, or CSI-RS in the slot if a reception would overlap with any symbol from the set of symbols. The UE does not expect the set of symbols of the slot to be indicated as downlink by tdd-UL-DL-ConfigurationCommon or tdd-UL-DL-ConfigurationDedicated.

For a set of symbols of a slot indicated to a UE by pdcch-ConfigSIBI in MIB for a CORESET for Type0-PDCCH CSS set, the UE does not expect the set of symbols to be indicated as uplink by tdd-UL-DL-ConfigurationCommon, or tdd-UL-DL-ConfigurationDedicated.

If a UE is scheduled by a DCI format to receive PDSCH over multiple slots, and if tdd-UL-DL-ConfigurationCommon, or tdd-UL-DL-ConfigurationDedicated, indicate that, for a slot from the multiple slots, at least one symbol from a set of symbols where the UE is scheduled PDSCH reception in the slot is an uplink symbol, the UE does not receive the PDSCH in the slot.

If a UE is scheduled by a DCI format to transmit PUSCH over multiple slots, and if tdd-UL-DL-ConfigurationCommon, or tdd-UL-DL-ConfigurationDedicated, indicates that, for a slot from the multiple slots, at least one symbol from a set of symbols where the UE is scheduled PUSCH transmission in the slot is a downlink symbol, the UE does not transmit the PUSCH in the slot.

If a UE is configured with multiple serving cells and is provided half-duplex-behavior=‘enable’, is not capable of simultaneous transmission and reception on any of the multiple serving cells, indicates support of capability for half-duplex operation in CA with unpaired spectrum, and is not configured to monitor PDCCH for detection of DCI format 2-0 on any of the multiple serving cells the UE determines a reference cell for a symbol as an active cell with the smallest cell index among serving cells where the symbol is configured as downlink, or uplink, as indicated by tdd-UL-DL-ConfigurationCommon or tdd-UL-DL-Configuration Dedicated, uplink, if the symbol is flexible and the UE is configured to transmit SRS, PUCCH, PUSCH, or PRACH on the symbol, downlink, if the symbol is flexible and the UE is configured to receive PDCCH, PDSCH or CSI-RS on the symbol.

If a UE is configured with multiple serving cells in a frequency band and is provided half-duplex-behavior=‘enable’, is not capable of simultaneous transmission and reception on any of the multiple serving cells, indicates support of capability for half-duplex operation in CA with unpaired spectrum, and is not configured to monitor PDCCH for detection of DCI format 2_0 on any of the multiple serving cells, the UE does not expect a symbol to be indicated as downlink or uplink on the reference cell and as uplink or downlink on another cell, respectively, by tdd-UL-DL-ConfigurationCommon or by tdd-UL-DL-ConfigurationDedicated, tdd-UL-DL-ConfigurationCommon or tdd-UL-DL-ConfigDedicated to indicate a symbol as downlink on the reference cell and to detect a DCI format scheduling a transmission on the symbol on another cell, and to be configured by higher layers to receive PDCCH, PDSCH, or CSI-RS on a flexible symbol on the reference cell and to detect a DCI format scheduling a transmission on the symbol on another cell.

If the reference cell and another cell for a UE operate in different frequency bands and if the UE is configured with multiple serving cells and is provided half-duplex-behavior=‘enable’, is not capable of simultaneous transmission and reception on any of the multiple serving cells, indicates support of capability for half-duplex operation in CA with unpaired spectrum, and is not configured to monitor PDCCH for detection of DCI format 2-0 on any of the multiple serving cells, the UE assumes symbol as flexible, is not required to receive higher layer configured PDCCH, PDSCH, or CSI-RS and not expected to transmit higher layers configured SRS, PUCCH, PUSCH, or PRACH, when tdd-UL-DI-ConfigurationCommon or tdd-UL-DL-ConfigurationDedicated indicates symbol as downlink or uplink on the other cell and as uplink or downlink for the reference cell, respectively, transmits a signal/channel scheduled by a DCI format on a symbol of the other cell when the symbol is indicated as downlink by tdd-UL-DL-ConfigurationCommon or tdd-UL-DL-ConfigDedicated for the reference cell, and is not required to receive a higher layer configured PDCCH, PDSCH, or CSI-RS on flexible symbols on the reference cell in a set of symbols, if the UE detects a DCI format scheduling a transmission on one or more symbols in the set of symbols on the other cell.

If a UE is configured with multiple serving cells and is provided half-duplex-behavior=‘enable’, is not capable of simultaneous transmission and reception on any cell from the multiple serving cells, indicates support of capability for half-duplex operation in CA with unpaired spectrum, and is not configured to monitor PDCCH for detection of DCI format 2-0 on any of the multiple serving cells, the UE does not expect tdd-UL-DL-ConfigurationCommon or tdd-UL-DL-ConfigurationDedicated for the reference cell to indicate a symbol as uplink and to detect a DCI format scheduling a reception on the symbol on another cell, does not expect to be configured by higher layers to transmit SRS, PUCCH, PUSCH, or PRACH on a flexible symbol on the reference cell and to detect a DCI format scheduling a reception on the symbol on another cell, does not transmit a PUCCH, PUSCH or PRACH that is configured by higher layers on a set of symbols on another cell if at least one symbol from the set of symbols is indicated as downlink by tdd-UL-DL-ConfigurationCommon or tdd-UL-DI-ConfigurationDedicated or is a symbol corresponding to a PDCCH, PDSCH, or CSI-RS reception that is configured by higher layers on the reference cell, does not transmit a SRS that is configured by higher layers on a set of symbols on another cell if the set of symbols is indicated as downlink by tdd-UL-DL-ConfigurationCommon or tdd-UL-DL-ConfigurationDedicated or corresponds to a PDCCH, PDSCH or CSI-RS reception that is configured by higher layers on the reference cell, does not receive a PDCCH, PDSCH or CSI-RS that is configured by higher layers on a set of symbols on another cell if at least one symbol from the set of symbols is indicated as uplink by tdd-UL-DI-ConfigurationCommon or tdd-UL-DL-ConfigurationDedicated or is a symbol corresponding to a SRS, PUCCH, PUSCH, or PRACH transmission that is configured by higher layers on the reference cell, assumes a symbol indicated as downlink or uplink by tdd-UL-DI-ConfigurationCommon or tdd-UL-DL-ConfigurationDedicated on another cell to be flexible, if the UE is respectively configured by higher layers to transmit SRS, PUCCH, PUSCH, or PRACH or to receive PDCCH, PDSCH, or CSI-RS on the reference cell, does not expect to detect a first DCI format scheduling a transmission or reception on a symbol on a first cell and a second DCI format scheduling a reception or transmission on the symbol on a second cell, respectively.

For PUSCH repetition Type B, the UE determines invalid symbol(s) for PUSCH repetition Type B transmission by using a symbol that is indicated as downlink by tdd-UL-DL-ConfigurationCommon or tdd-UL-DL-ConfigurationDedicated is considered as an invalid symbol for PUSCH repetition Type B transmission. For operation in unpaired spectrum, symbols indicated by ssb-PositionsInBurst in SIB1 or ssb-PositionsInBurst in ServingCellConfigCommon for reception of SS/PBCH blocks are considered as invalid symbols for PUSCH repetition Type B

| | | | FDD − | FR1 − |
|---|---|---|---|---|
| | | | TDD | FR2 |
| Definitions for parameters | Per | M | DIFF | DIFF |
| half-DuplexTDD-CA-SameSCS-r16 | BC | No | TDD | N/A |
| Indicates whether the UE supports | | | only | |
| directional collision handling between | | | | |
| reference and other cell(s) for half-duplex | | | | |
| operation in TDD CA with same SCS. The | | | | |
| UE can include this field, only if | | | | |
| simultaneousRxTxInterBandCA is not | | | | |
| present. | | | | |

transmission.

$$BC = band combination ; M = mandatory ; DIFF = functionality difference$$

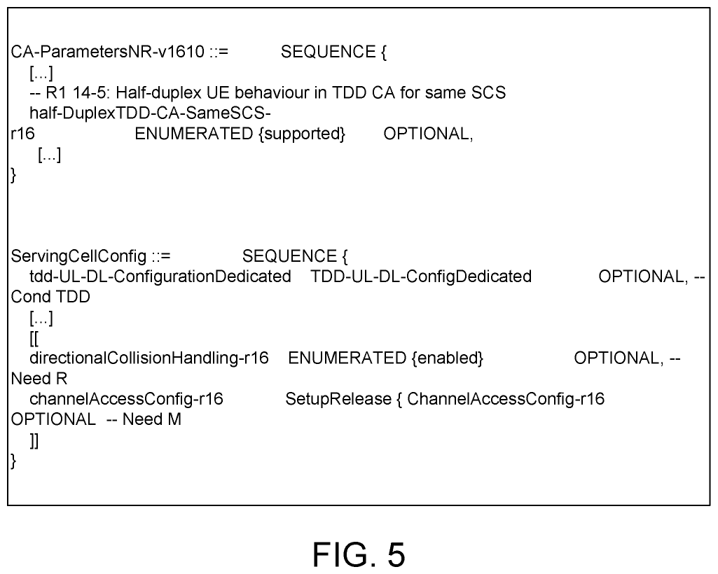

FIG. 5 depicts example code for supporting half duplex operations and for enabling directional collision handling.

For ServingCellConfig field descriptions, directionalCollisionHandling indicates that a serving cell is using directional collision handling between a reference and other cell(s) for half-duplex operation in TDD CA with same SCS as specified in TS 38.213, clause 11.1. The half-duplex operation only applies within the same frequency range and cell group. The network only configures this field for TDD serving cells that are using the same SCS.

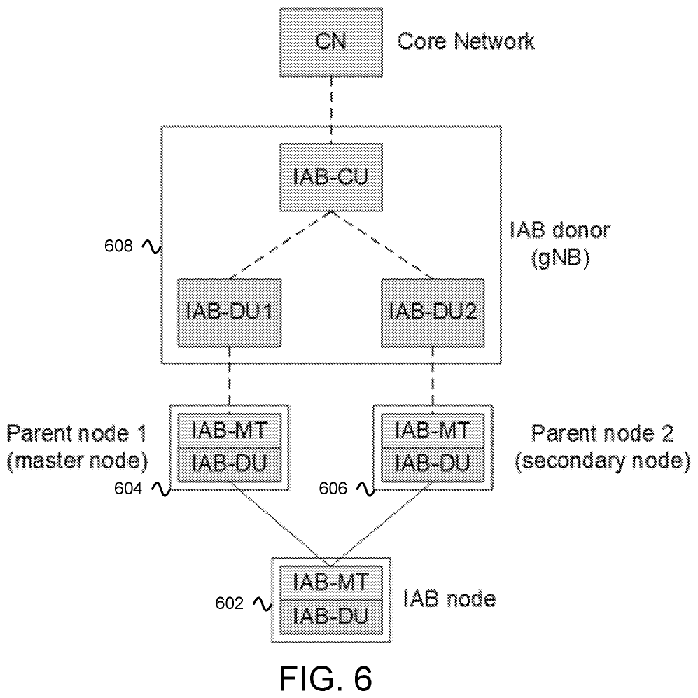

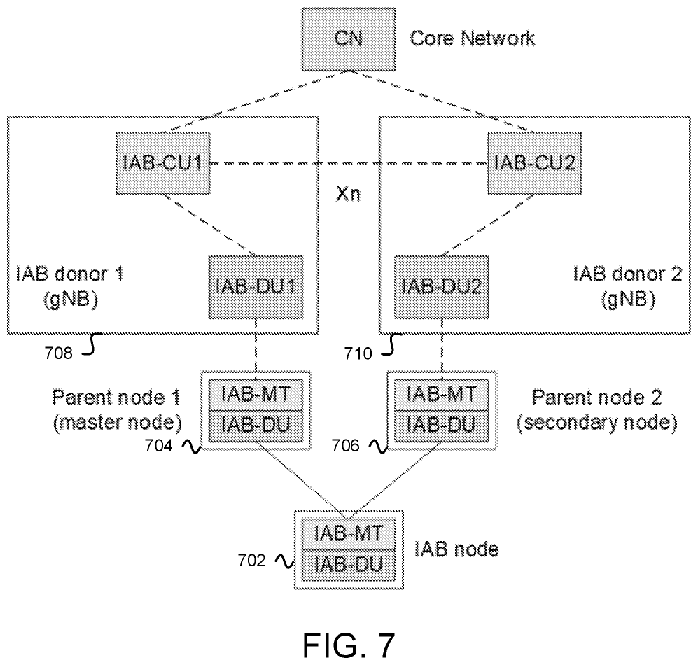

Regarding IAB DC Scenarios, FIG. 6 illustrates an example IAB system with DC at an IAB node 602 where the parent nodes 604, 606 of the IAB node 602 are configured by one IAB donor 608. This architecture may be referred to as the intra-donor scenario. An alternative scenario is dual connectivity at an IAB node 702 wherein each parent node 704, 706 may be configured by different IAB donor 708, 710. This architecture may be referred to as the inter-donor scenario, as shown in FIG. 7.

In the examples shown in these figures, multiple connections and interfaces are present. Examples may include the physical layer (L1) connection over the Uu link that connect an IAB-MT of the IAB node to serving IAB-DUs of parent nodes, (e.g., as specified in 3GPP RAN1 technical specifications including [TS 38.211], [TS 38.212], [TS 38.213], [TS 38.214], and [TS 38.215]), medium access control (“MAC”) sublayer of the link layer (L2) (e.g., as specified in the RAN2 technical specification [TS 38.321]), radio resource control (“RRC”) at layer 3 (e.g., as specified in the RAN2 technical specification [TS 38.331]), and higher layer interfaces (e.g., as specified in RAN3 technical specifications including [TS 38.420] and [TS 38.423] for Xn, [TS 38.470] and [TS 38.473] for F1), and so on.

Several of these interfaces are not shown or labeled in those figures for the sake of brevity. However, it should be noted that IAB nodes in an IAB system may configured by an IAB-CU of an IAB donor, which may be connected to the IAB nodes over multiple hops (wireless links) over an F1 interface.

Throughout the present disclosure, for the sake of brevity, physical layer and link layer signaling (including MAC signaling) may be referred to as “lower-layer” signaling, dynamic signaling, L1/L2 signaling, and the like. For example, a lower-layer signaling may refer to a DCI message on a PDCCH, a UCI message on a PUCCH or a PUSCH, a MAC message, or a combination thereof, unless the term “lower-layer” is specified for an embodiment or realization to refer to a specific signaling such as a DCI message or a MAC message.

Similarly, throughout the present disclosure, signaling by RRC and/or signaling over interfaces such as F1 and Xn may be referred to as “higher-layer” signaling, a higher-layer configuration, or a configuration. For example, a higher-signaling or configuration may refer to an RRC information element (“IE”), an F1AP IE, an XnAP IE, and the like. A configuration may comprise multiple configuration messages or multiple IEs, each of which from a same or different entity/layer. According to this description, the term “RRC-D” and “RRC-U,” which are defined later to describe TDD DL-UL conflicts, may or may not refer to an RRC configuration specifically; instead, the term may refer to a higher-layer configuration, in general, which may comprise configuration from other entities/layers.

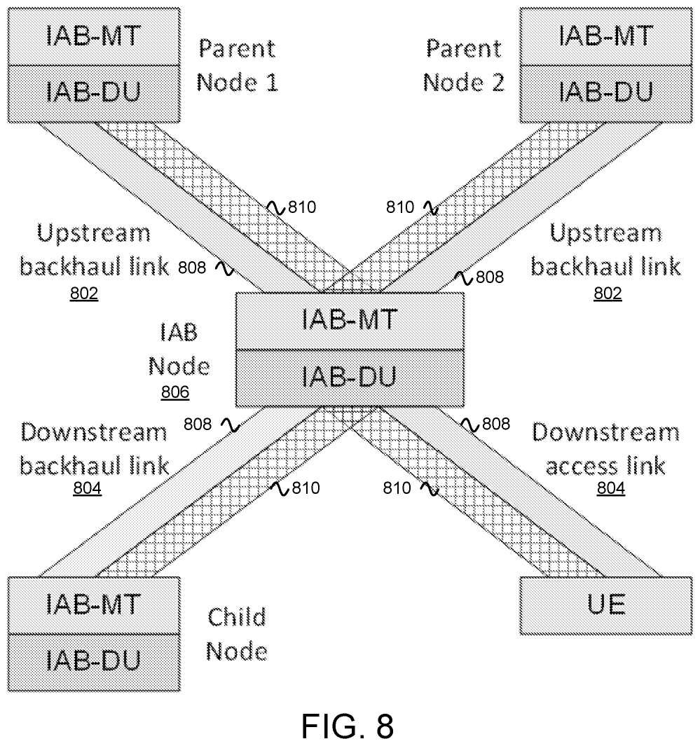

The different scenarios for enhanced resource multiplexing and simultaneous operations are depicted in FIG. 8. In this conceptual schematic, each of the backhaul and access links in upstream 802 and downstream 804 of the IAB node 806 may have resources 808 that are not overlapping with resources used in other links. However, some resources 810 on one link may be overlapping with resources on one or multiple other links in at least one of time, frequency, or spatial domains. Particularly, when resources are overlapping in the time domain, methods for simultaneous operations may be applied.

In the present disclosure, reference is made to the aforementioned references as methods similar to those proposed in the said references are applicable for multiplexing among upstream links, e.g., DC scenarios.

Regarding extension of CA TDD conflict resolution to IAB DC, consider the following table of scenarios for DL-UL conflict resolution in the case of IAB DC:

| Scenario | Symbol on Cell-I/CG-I | Symbol on Cell-II/CG-II |
|---|---|---|
| 1 | TDD-Config-D | TDD-Config-U |
| 2 | TDD-Config-D | RRC-U |
| 3 | TDD-Config-D | Dynamic-U |
| 4 | TDD-Config-U | TDD-Config-D |
| 5 | TDD-Config-U | RRC-D |
| 6 | TDD-Config-U | Dynamic-D |
| 7 | RRC-D | RRC-U |
| 8 | RRC-U | RRC-D |
| 9 | Dynamic-D | Dynamic-U |
| 10 | Dynamic-U | Dynamic-D |
| 11 | RRC-U | TDD-Config-D |
| 12 | Dynamic-U | TDD-Config-D |
| 13 | RRC-D | TDD-Config-U |
| 14 | Dynamic-D | TDD-Config-U |
| 15 | RRC-U | Dynamic-D |
| 16 | RRC-D | Dynamic-U |
| 17 | Dynamic-U | RRC-D |
| 18 | Dynamic-D | RRC-U |

The following definitions are used throughout this disclosure for the sake of brevity:
TDD-Config-D: A symbol configured as downlink (D) by TDD-UL-DL-ConfigurationCommon and/or TDD-UL-DL-ConfigDedicated. TDD-Config-D may also refer to a symbol configured as D by a new TDD configuration such as a TDD-UL-DL-Configuration-r17, which may be introduced in Rel-17 for enhanced duplexing in IAB systems.
TDD-Config-U: A symbol configured as uplink (U) by TDD-UL-DL-ConfigurationCommon and/or TDD-UL-DL-ConfigDedicated. TDD-Config-U may also refer to a symbol configured as U by a new TDD configuration such as a TDD-UL-DL-Configuration-r17, which may be introduced in Rel-17 for enhanced duplexing in IAB systems.
TDD-Config-F: A symbol configured as flexible (F), or not configured as D or U, by TDD-UL-DL-Configuration Common or TDD-UL-DL-ConfigDedicated or a new TDD configuration TDD-Configuration-r17. For example, if no TDD configuration is provided to an IAB-MT, any symbol may be a TDD-Config-F symbol.
RRC-D: A symbol corresponding to a higher-layer configured downlink channel or signal such as PDCCH, PDSCH, CSI-RS, or the like on a TDD-Config-F on the same cell or cell group.
RRC-U: A symbol corresponding to a higher-layer configured uplink channel or signal such as PUCCH, PUSCH, PRACH, SRS, or the like on a TDD-Config-F of the same cell or cell group.
Dynamic-D: A symbol scheduled as D by a DCI message on a TDD-Config-F symbol of the same cell or cell group. For example, a symbol on which a PDSCH is scheduled by a DCI message may be a Dynamic-D. This definition may exclude DCI format 2-0 or the like by which a symbol direction is indicated without a scheduling.
Dynamic-U: A symbol scheduled as U by a DCI message on a TDD-Config-F symbol of the same cell or cell group. For example, a symbol on which a PUSCH is scheduled by a DCI message may be a Dynamic-U. This definition may exclude DCI format 2-0 or the like by which a symbol direction is indicated without a scheduling.

It is also noted that, in one embodiment, a synchronization signal and physical broadcast channel (“SS/PBCH”) block may or may not be considered a downlink reference signal in the category of RRC-D. For example, a symbol on which an SS/PBCH block is configured within an SSB-based measurement timing configuration (“SMTC”) of an IAB-MT may not be considered an RRC-D by the IAB-MT. Similarly, a symbol on which a reference signal for mobility management is configured may not be considered an RRC-D symbol. In any such cases, the symbol may take a higher priority, i.e., leading to an “error case” or “dropping” or “overriding” a conflicting attribute indicated by another cell.

In further embodiments, as briefly mentioned, some dynamic signaling such as dynamic slot format indication (“SFI”) by DCI format 2-0 and/or availability indication (“AI”) by DCI format 2-5 may or may not be considered Dynamic-D or Dynamic-U signaling. Additional scenarios and methods including those types of dynamic signaling will be introduced later in this disclosure.

Regarding conflict resolution actions, the keywords used for defining conflict resolution rules include:
Error case: This phrase may refer to a case that is not expected to occur. For example, a certain combination of D and U indication for a symbol may not be expected by an IAB-MT of an IAB node. In practice, if an error case happens, a behavior of the subject entity such as the IAB-MT may be determined by implementation. For example, in response to an error case, the IAB-MT may:
   drop a conflicting attribute or an associated operation;
   override a conflicting attribute;
   ignore one or multiple instances of any or all of the operations (transmission and/or receptions) associated with one or multiple of the conflicting attributes;
   generate and transmit an error/notification message to another entity such as a parent node or an IAB-CU; and/or
   send an error/notification message to a higher layer.
In the standards, an error case may be specified as an entity “not expecting” the case. Alternatively, or additionally, an error case may be specified by the expected behavior of the entity in response to the error case.
Dropping an attribute: This phrase may refer to a behavior whereby an entity such as an IAB-MT does not attend to an attribute because it is considered lower priority. For example, a D or U attribute indicated by a lower priority cell/CG or by a lower-priority type of configuration or signaling may be neglected by the IAB-MT on the associated cell/CG. In this context, dropping an attribute may mean that one or multiple conflicting instances are dropped, e.g., one or multiple symbols that conflict with another schedule may be dropped while other instances are attended to as indicated. Alternatively, dropping an attribute may mean that all instances are neglected including instances that a conflict with another operation does not occur or the subject entity may be idle.
In the standards, a dropping rule may be specified as the entity “not required” to attend to an operation associated with the dropped attribute or operation, be “allowed” to neglect the operation, and the like.
Overriding an attribute: This phrase may refer to a behavior whereby an entity such as an IAB-MT overrides an attribute, which may be associated with a cell/CG or a type of signaling that may otherwise be considered of higher priority. For example, a configuration may generally be considered a higher priority signaling compared to a lower-layer dynamic signaling. However, in some embodiments, if the dynamic signaling indicates a conflicting attribute with a configured attribute for a same symbol, the latter may be overridden by a rule.
In the standards, an overriding may be specified implicitly by “allowing” an entity such as an IAB-MT to perform an operation that is conflicting with the overridden attribute, for example performing an uplink transmission on a downlink symbol or vice versa.
Similar to a response to an “error case,” a dropping or overriding behavior may comprise, or accompanied by, generating and transmitting an error message or a notification message to another entity such as a parent node or an IAB-CU.
There may or may not be strict differences between dropping an overriding in standards agreements and/or specifications. The embodiments in which the above terminology is used in this disclosure are intended to provide examples of behaviors specified by the standard, configured by the network, or implemented by the vendor, at an entity such as an IAB node, and do not intend to establish strict ties between the said behaviors and a specific terminology. By extension, as observed for the definition of the phrase “error case,” an implementation to handle an error case may comprise a dropping and/or overriding behavior.

Regarding Cell-I/CG-I and Cell-II/CG-II, if an IAB-MT identifies a conflict between two cells, it may determine one cell as Cell-I and another cell as Cell-II. In some embodiments, determining Cell-I and Cell-II may be independent of signaling specific to a resource, i.e., determining Cell-I and Cell-II between the two cells may be same for all symbols as a long as the said two cells are concerned. Alternatively, determining Cell-I and Cell-II may be specific to a resource, e.g. specific to a symbol, similar to the specification for CA TDD collision handling TEI.

Similarly, if an IAB-MT identifies a conflict between two cell groups (“CGs”), or two cells from different CGs, determining Cell-I and Cell-II may or may not depend, fully or partially, on the relative status of the CGs, e.g. which of them is a master cell group (“MCG”) and which of them is a secondary cell group (“SCG”).

In some embodiments, Cell-I may refer to a primary cell (“PCell”) in a cell group (“CG”) while Cell-II may refer to another cell in the same CG.

In some embodiments, Cell-I may refer to a Cell-I and Cell-II may be determined relatively based on at least one of:
whether either of them is a primary cell in a CG;
whether either of them is comprised by a master cell group (MSG);
their corresponding cell indices;
the type of signaling that indicates a D/U on one cell versus that on the other cell;
whether either of them may be defined as a “reference cell” according to CA TDD collision handling TEI; and/or
whether either of them is determined a “reference cell” for an enhanced timing alignment scheme.

For example:
among cells in a CG, a primary cell may take a higher priority to be determined Cell-I;
a cell in an MCG may take a higher priority to be determined Cell-I compared to a cell in an SCG;
among two or more cells, a cell with the smallest cell index may take a higher priority to be determined Cell-I;
a cell with a D/U indication by a higher-layer configuration for the subject resource/symbol may take a higher or lower priority to be determined Cell-I compared to a cell with a D/U indication by a lower-layer dynamic signaling;
a cell determined as a “reference cell” according to CA TDD collision handling TEI may take a higher priority to be determined Cell-I;
a cell that has been determined/indicated a reference cell for an enhanced timing alignment scheme, such as a TX timing alignment (Case-6) or RX timing alignment (Case-7), may take a higher priority to be determined Cell-I.

It should be noted that multiple of such rules may be applied to determine Cell-I and Cell-II. In some embodiments, an ordering of such rules may be specified or determined whereby an entity such as an IAB-MT examines rule criteria one by one. For example, if cells belong to different CGs, then a cell in the MCG may be determined Cell-I; else, if exactly one cell is a primary cell (PCell), then the said cell may be determined Cell-I; else, if exactly one cell has indicated a D/U attribute for the symbol by a higher-layer configuration such as a TDD configuration or a configured channel or a configured reference signal, then the said cell may be determined Cell-I; else a cell with the smallest cell index may be determined Cell-I.

In some embodiments, the multiple rules may be combined by other means such as a weighted criterion, a priority parameter configured by a higher layer, a quality-of-service (QOS) associated with an attribute indication, and the like.

In some embodiments, collision handling among cells within a CG (such as an MCG or an SCG) may be handled by the existing rules specified by the CA TDD collision handling TEI, while conflict resolution among CGs may follow methods proposed in the present disclosure. In this case, the proposed may be as specified by the standard by referring to CGs rather than cells. Therefore, in the present disclosure, we may refer to CG-I and CG-II when conflict resolution among CGs is concerned.

In the standard specification or agreements, Cell-I may be referred to as a “reference cell” or the like. Similarly, Cell-II may be referred to as an “other cell” or the like. Alternatively, a behavior related to Cell-I and Cell-II may be specified without a reference to such terms.

It should be noted that, although the methods proposed in this disclosure are described with emphasis on two cells/CGs, the methods may be extended to multiple cells/CGs with conflicting attribute indications. Examples of how to extend the methods to multiple cells/CGs are provided later.

Regarding conflict resolution methods, example behaviors for an IAB-MT is provided, wherein the IAB-MT experiences a conflict for a direction of communication (uplink transmission and a downlink reception) on a resource (such as a symbol) in a DC/CA scenario according to the aforementioned table of scenarios.

### Scenarios 1, 2, 7, 13:

In an embodiment, the IAB-MT is allowed to drop or override the U attribute indicated in association with Cell-II. In an alternative embodiment, the IAB-MT is allowed to drop or override the D attribute indicated in association with Cell-I. In yet another embodiment, the IB-MT may determine an error case. In yet another embodiment, the IAB-MT may drop or override a D attribute or U attribute in an inter-band scenario, but it may determine an error case in an intra-band scenario. In yet another embodiment, the IAB-MT may drop or override a D attribute or U attribute in an inter-carrier scenario, but it may determine an error case in an intra-carrier scenario.

### Scenarios 4, 5, 8, 11:

In an embodiment, the IAB-MT is allowed to drop or override the D attribute indicated in association with Cell-II. In an alternative embodiment, the IAB-MT is allowed to drop or override the U attribute indicated in association with Cell-I. In yet another embodiment, the IB-MT may determine an error case. In yet another embodiment, the IAB-MT may drop or override a D attribute or U attribute in an inter-band scenario, but it may determine an error case in an intra-band scenario. In yet another embodiment, the IAB-MT may drop or override a D attribute or U attribute in an inter-carrier scenario, but it may determine an error case in an intra-carrier scenario.

### Scenarios 3, 14, 16, 18:

In an embodiment, the IAB-MT is allowed to drop or override the U attribute indicated in association with Cell-II. In an alternative embodiment, the IAB-MT is allowed to drop or override the D attribute indicated in association with Cell-I. In yet another embodiment, the IB-MT may determine an error case. In yet another embodiment, the IAB-MT may drop or override a D attribute or U attribute in an inter-band scenario, but it may determine an error case in an intra-band scenario. In yet another embodiment, the IAB-MT may drop or override a D attribute or U attribute in an inter-carrier scenario, but it may determine an error case in an intra-carrier scenario.
In yet another embodiment, the IAB-MT may give a higher priority to the dynamic signaling, i.e., the dynamic signaling such as a scheduling DCI, a slot format indication (SFI), or an availability indication (AI) may override an attribute configured by a higher layer signaling. Conversely, the IAB-MT may give a higher priority to the higher-layer configuration, i.e., the higher-layer configuration such as a configured control channel, a configured shared channel, a configured random access channel, or reference signal may override an attribute indicated by a dynamic signaling.

### Scenarios 6, 12, 15, 17:

In an embodiment, the IAB-MT is allowed to drop or override the D attribute indicated in association with Cell-II. In an alternative embodiment, the IAB-MT is allowed to drop or override the U attribute indicated in association with Cell-I. In yet another embodiment, the IB-MT may determine an error case. In yet another embodiment, the IAB-MT may drop or override a D attribute or U attribute in an inter-band scenario, but it may determine an error case in an intra-band scenario. In yet another embodiment, the IAB-MT may drop or override a D attribute or U attribute in an inter-carrier scenario, but it may determine an error case in an intra-carrier scenario.
In yet another embodiment, the IAB-MT may give a higher priority to the dynamic signaling, i.e., the dynamic signaling such as a scheduling DCI, a slot format indication (SFI), or an availability indication (AI) may override an attribute configured by a higher layer signaling. Conversely, the IAB-MT may give a higher priority to the higher-layer configuration, i.e., the higher-layer configuration such as a configured control channel, a configured shared channel, a configured random access channel, or reference signal may override an attribute indicated by a dynamic signaling.

### Scenarios 9, 10:

In an embodiment, the IAB-MT is allowed to drop or override a U/D attribute indicated in association with Cell-II. In an alternative embodiment, the IAB-MT is allowed to drop or override a D/U attribute indicated in association with Cell-I. In yet another embodiment, the IB-MT may determine an error case. In yet another embodiment, the IAB-MT may drop or override a D/U attribute in an inter-band scenario, but it may determine an error case in an intra-band scenario. In yet another embodiment, the IAB-MT may drop or override a D/U attribute in an inter-carrier scenario, but it may determine an error case in an intra-carrier scenario.
In yet another embodiment, the IAB-MT may give a higher priority to a dynamic signaling received earlier, i.e., a first dynamic signaling such as a scheduling DCI, an slot format indication (SFI), or an availability indication (AI) that is received earlier may be considered by the IAB-MT while an operation associated with a second dynamic signaling received later may be neglected. Conversely, the IAB-MT may give a higher priority to a dynamic signaling received later, i.e., a second dynamic signaling such as a scheduling DCI, a slot format indication (SFI), or an availability indication (AI) that is received later may be considered by the IAB-MT while an operation associated with a first dynamic signaling received earlier may be neglected.
In some embodiments, a second attribute may be dropped or overridden in favor of a first attribute based on a higher-layer configuration parameter, a quality-of-service (QOS) associated with either attribute, and/or the like.

Regarding extension to conflict among multiple cells/CGs, as mentioned earlier, although the methods proposed in this disclosure are described with emphasis on two cells/CGs, the methods may be extended to multiple cells/CGs with conflicting attribute indications. Examples of how to extend the methods to multiple cells/CGs are provided below.

In an embodiment, if an IAB-MT experiences a conflict of attributes among multiple cells, it may determine one cell as Cell-I and one or multiple cells as Cell-II. Then, the IAB-MT may determine the associated behavior based upon the behaviors specified for conflict resolution between the Cell-I and each of the Cell-IIs.

In one realization of this embodiment, if the said behaviors are consistent or identical, then the IAB-MT may perform the associated conflict resolution. For example, if the said behaviors are dropping an attribute on a Cell-II, then the IAB-MT may drop the attributes on the Cell-IIs.

In another realization, if the said behaviors are not identical, then the IAB-MT may perform the conflict resolution associated with a most strict behavior. For example, in the case that a behavior associated with a conflict between the Cell-I and a first Cell-II is dropping an attribute while a behavior associated with a conflict between the Cell-I and a second Cell-II is an error case, then the IAB-MT may perform a conflict resolution according to the error case. Determining which conflict resolution is “stricter” than another conflict resolution may be determined by the standard, a configuration, or a signaling.

In yet another realization, if the said behaviors are not consistent, then the IAB-MT may perform a conflict resolution for each of the pairs of cells, i.e. the Cell-I and each of the Cell-IIs, separately. For example, IAB-MT may drop an attribute associated with one Cell-II, override an attribute associated with Cell-I to F, and determine an error case in association with yet another Cell-II simultaneously.

In yet another realization, inconsistent or unidentical conflicts may automatically result in an error case or they may be handled by implementation.

In another embodiment, if an IAB-MT experiences a conflict of attributes among multiple cells, it may resolve the conflicts among each of the pair of cells separately. In this case, a cell may be determined a Cell-I in one conflict while it may be determined a Cell-II in another conflict.

In one realization of this embodiment, if a behavior determined for a cell is inconsistent with another behavior determined for the said cell, the IAB-MT may perform a most strict conflict resolution among the conflict resolutions associated with the determined behaviors.

In another embodiment, unidentical or inconsistent behaviors or conflict resolutions for a cell may automatically raise an error case or may be handled by implementation.

Regarding capability signaling, for specifying CA TDD collision handling at a UE, two higher-layer parameters are being considered—see the background section for the status of the current RAN1 and RAN2 specifications.

One parameter is a capability parameter that indicates half-duplex operation by the UE. When this capability is configured as ‘supported’, the UE is capable of half-duplex operation in a CA TDD mode when values of OFDM numerology or subcarrier spacing (SCS) are the same.

Another parameter is a higher-layer configuration for directional collision handling. If this parameter is configured as ‘enabled’, the UE handles collision resolution as specified by the TEI. Otherwise, the UE should still be capable of half-duplex operation on CA TDD mode if it is ensured that directional collisions do not occur.

In an embodiment, same or similar signaling may be used for capability signaling and configuration of conflict resolution at an IAB-MT connected to two or multiple parent nodes.

In another embodiment, half-duplex operation may be determined by a TDM-only capability signaling by the IAB node and/or a lack of simultaneous TX/RX operation capability at the IAB node.

In yet another embodiment, capability signaling and/or higher-layer configuration may determine conflict resolution behaviors expected by an IAB node for different scenarios.

In yet another embodiment, a multi-panel capability signaling may determine, alternatively or additionally, whether and how TDD conflicts are resolved by an IAB node. For example, an IAB node with multiple antenna panels and RF frontends may follow less strict conflict resolution methods compared to a single-panel or TDM-only IAB node.

Regarding inter-band, intra-band inter-carrier, intra-carrier, each of the capability signaling, configuration, and conflict resolution methods in the present disclosure may be specified differently for the following scenarios:
Inter-band DC, e.g., a DC scenario wherein cells are configured on different frequency bands.
Intra-band inter-carrier DC, e.g., a DC scenario wherein cells are configured on different carriers withing a frequency band.
Intra-band intra-carrier DC, e.g., a DC scenario wherein cells are configured on a same carrier.

In practice, conflict resolution for inter-band scenarios may be less strict as an IAB-MT may not share RF frontend and antenna hardware for communication over different bands.

In contrast, an IAB-MT may use a same RF frontend and antenna hardware in an intra-band scenario, which leads to stricter constraints on direction of communication (D/U) on a symbol, power imbalance, total power, beamforming, and timing alignment.

Finally, in an intra-carrier scenario, an IAB-MT may follow the strictest of conflict resolution methods to handle resource multiplexing constraints and the constraints mentioned above. Particularly, in intra-carrier and possibly in intra-band inter-carrier scenarios, a multi-panel capability may be needed to avoid an error case in a certain scenario.

As a result, an IAB node may follow different procedures for determining a Cell-I, determining a D/U conflict scenario, a prioritization or weighing rule, and the like when experiencing a D/U conflict an inter-band DC case, an intra-band inter-carrier DC case, and an intra-carrier DC case. The different procedures may be determined by the standard, a configuration, and/or a signaling.

Regarding different SCS, asynchronous operation, enhanced timing alignment, the CA TDD collision handling TEI addressed CA scenarios where all the cells have a same OFDM numerology or SCS. Here, we extend the CA collision handling the methods proposed in the present disclosure to the case of multiple value of SCS. This scenario may be realized, in principle, when an IAB node uses a larger number of IFFT/FFT windows for OFDM operations compared to the number of antenna panels and RF chains for those operations. As a result, a half-duplex antenna panel may be used for a transmission or a reception at a time while allowing the IAB node to transmit or receive OFDM signals with different numerologies.

In some embodiments, SCS of conflicting cells may impact how an IAB node determines a Cell-I and a Cell-II in the case of a conflict. In one realization, a cell with a smaller SCS may be determined Cell-I. In another realization, a cell with a larger SCS may be determined Cell-I.

In some embodiments, a first symbol with a first SCS on a first cell may overlap with a second symbol with a second SCS on a second cell in the time domain. Then, if attributes indicated for the first symbol and the second symbol are conflicting, that may trigger a conflict resolution. The overlap may be full or partial for either of the symbols.

Another case where symbols may not be aligned is asynchronous DC scenarios. Embodiments are presented next.

In some embodiments, a synchronicity parameter may impact how an IAB node determines a Cell-I and a Cell-II in the case of a conflict. In one realization, a cell that is synchronous with a reference cell such as a primary cell or a master cell group (MCG) may be determined Cell-I.

In some embodiments, a first symbol on a first cell may overlap with a second symbol on a second cell in the time domain where the cells are not synchronous. Then, if attributes indicated for the first symbol and the second symbol are conflicting, that may trigger a conflict resolution. The overlap may be full or partial for either of the symbols.

Yet another case where symbols may not be aligned is enhanced timing alignment such as a TX timing alignment (Case-6) or an RX timing alignment (Case-7) for an uplink transmission (UL-TX). Embodiments are presented next.

In some embodiments, a timing alignment on a cell may impact whether an IAB node determines that cell as Cell-I in the case of a conflict. In one realization, a cell performing a TX alignment scheme may be determined Cell-I. In another realization, a cell performing an RX alignment scheme may be determined Cell-I. In yet another realization, a cell performing a timing advance (TA) according to Rel-15/16 TA may be determined Cell-I. In yet another realization, a reference timing alignment may be specified or configured, and then a cell following the timing alignment may be determined Cell-I.

In some embodiments, a first symbol on a first cell may overlap with a second symbol on a second cell in the time domain where the cells are not following identical timing alignment schemes or values. Then, if attributes indicated for the first symbol and the second symbol are conflicting, that may trigger a conflict resolution. The overlap may be full or partial for either of the symbols.

Regarding SFI conflicts and inter-parent coordination, in the description of conflict resolution methods for scenarios that involve a conflict with a “Dynamic-D” or a “Dynamic-U” symbol, it was mentioned that the dynamic signaling may or may not include dynamic slot format indication (SFI) such as indication by a DCI format 2-0. Indeed, the case of dynamic SFI was excluded from the CA TDD collision handling TEI and the specified rules are applicable if the UE “is not configured to monitor PDCCH for detection of DCI format 2-0 on any of the multiple serving cells.”

In an embodiment, an SFI message indicating a conflicting attribute for a symbol may raise an error case.

In another embodiment, an SFI message indicating a conflicting attribute for a symbol may override any other attribute for that symbol without a need to determine a Cell-I.

In yet another embodiment, an SFI message indicating a conflicting attribute for a symbol may be ignored by the IAB-MT.

Furthermore, parent nodes that provide serving cells for an IAB-MT may perform coordination signaling in order to avoid D/U conflicts. In some embodiments, the coordination signaling may be over a RAN3 interface such as an F1 interface. Alternatively, the IAB-MT may transmit information of attributes as indicated by an SFI message from a parent node to another parent node that provides a serving cell in the same band or carrier.

Regarding AI conflicts and inter-parent coordination, availability indication (AI) may also impact conflict resolution procedures. For example, an IAB node that has a limited number of antenna panels and RF chains for upstream and downstream operations may use a variable number of antenna panels and RF chains for communication with parent nodes as other antenna panels and RF chains may be used for communication with child nodes.

For example, if an IAB node with a total of two half-duplex antenna panels for downstream and upstream operations does not receive an availability indication for communication with a child node, the IAB node may use the two antenna panels for communication with parent nodes, hence allowing to perform a UL-TX to a first parent node and a DL-RX from a second parent node, simultaneously.

However, if the same IAB node receives an availability indication for communication with a child node, the IAB node may be left with only a single antenna panel for communication with both parents, hence possibly running into D/U conflicts if attributes for a symbol on the serving cells from the two parent nodes do not match.

In an embodiment, if an IAB node receives an AI message (such as a DCI format 2-5) that indicates a symbol as available, and if the availability attribute results in a D/U conflict in a time-overlapping symbol in the upstream, the IAB node may ignore the AI message for the symbol.

In another embodiment, if an IAB node receives an AI message that indicates a symbol as available, and if the availability attribute results in a D/U conflict in a time-overlapping symbol in the upstream, the IAB node may ignore the whole AI message.

In yet another embodiment, an IAB node may transmit a message to a parent node or to the IAB-CU, wherein the message comprises information of constraints on the usage of antenna panels by the IAB node. Then, a parent node may determine, or may be configured, to expect an error case on a symbol if it indicates a time-overlapping soft symbol as available.

In yet another embodiment, an IAB node receiving an AI for symbol may determine to drop or override a time-overlapping symbol or determine an error case for the time-overlapping symbol. The associated behavior may then comprise an error message or a notification message to the parent node that has transmitted the AI or a parent node that has not transmitted the AI, but provides a serving cell that has indicated a conflicting attribute for the time-overlapping symbol.

Furthermore, parent nodes that provide serving cells for an IAB-MT may perform coordination signaling in order to avoid D/U conflicts. In some embodiments, the coordination signaling may be over a RAN3 interface such as an F1 interface. Alternatively, the IAB-MT may transmit information of availability indication (as indicated by AI messages such as DCI format 2-5) from a parent node to another parent node that provides a serving cell in the same band or carrier.

The concept of time-overlapping (“TOL”) symbols/resources are described later in the present disclosure.

Regarding RRC-only vs. activation/trigger-based, an IAB node in an IAB system may be configured by an IAB-CU of an IAB donor that configures the IAB system. In an intra-donor DC scenario, parent nodes of the IAB node may be configured by the one IAB-CU, while in an inter-donor DC scenario, a first parent node of the IAB node may be configured by the IAB-CU while a second parent node of the IAB node may be configured by another IAB-CU comprised by another IAB donor. In addition to the configurations, the IAB node may receive lower-layer control signaling such as a MAC message or an L1 control message from another IAB node, for example a parent node, which may activate/deactivate or trigger transmission or reception of the configured signal/channel.

In the methods proposed in this disclosure, signals/channels configured by a higher layer (RRC-D and RRC-U in the table of scenarios) are potentially treated differently from signals/channels scheduled by a lower layer signaling (marked as a Dynamic-D and Dynamic-U in the table of scenarios) such as a PDSCH or a PUSCH scheduled by a DCI message from a parent. However, a signal/channel may be scheduled by a combination of higher-layer and lower-layer signaling. For example, while a reference signal is configured by RRC, a semi-persistent reference signal may be additionally activated/deactivated via MAC signaling, or an aperiodic reference signal may be triggered via DCI signaling.

In an embodiment, a signal/channel configured by a higher layer may always be treated as an RRC-D or RRC-U where the signal/channel is configured for downlink or uplink, respectively. For example, a CSI-RS may be treated as an RRC-D signal even if the CSI-RS is semi-persistent, i.e. activated and deactivated via MAC signaling, or aperiodic, i.e. triggered via DCI signaling. Similarly, an SRS may be treated as an RRC-U signal.

In another embodiment, a signal/channel configured by a higher layer may be treated as an RRC-D or RRC-U if the signal/channel is activated/deactivated via a MAC signaling, but not if the signal/channel is triggered by L1 signaling. For example, a periodic or semi-persistent CSI-RS may be treated as an RRC-D signal, but an aperiodic CSI-RS may be treated as a Dynamic-D signal.

In yet another embodiment, a signal/channel configured by a higher layer may be treated as an RRC-D or RRC-U if the signal/channel does not require lower-layer signaling for activation/deactivation or triggering. Otherwise, if a lower-layer signaling such as a MAC signaling or L1 signaling is used for scheduling the signal/channel, it may be treated a Dynamic-D or Dynamic-U signal/channel. For example, a periodic CSI-RS may be treated as an RRC-D signal, but a semi-persistent or aperiodic CSI-RS may be treated as a Dynamic-D signal.

In another example, a first transmission of a semi-persistent CSI-RS immediately following activation may be treated as a Dynamic-D signal, and the remaining semi-persistent CSI-RS transmissions may be treated as RRC-D signal. In yet another example, M first transmissions of a semi-persistent CSI-RS immediately following activation may be treated as a Dynamic-D signal, wherein M is an integer, and the remaining semi-persistent CSI-RS transmissions may be treated as RRC-D signal. In yet another example, a number of transmissions of a semi-persistent CSI-RS immediately following activation may be treated as a Dynamic-D signal based on a time threshold as explained below.

In yet another embodiment, a signal/channel configured by a higher layer may be treated as an RRC-D or RRC-U provided that any lower-layer signaling, such as a MAC signaling or L1 signaling, that activates/deactivates or triggers the signal/channel follows a timing as specified in the standard and/or configured by the network.

In one realization of this embodiment, a time threshold may be specified or configured for receiving the lower-layer signaling such as a MAC message or a DCI message from a parent node. The time threshold may be associated with a specific signal/channel configured by a higher layer. Then, if an IAB node receives the lower-layer signaling no later than the time threshold, the IAB node may treat the signal/channel as RRC-D or RRC-U (if the signal/channel is configured for downlink or uplink, respectively). However, if the IAB node receives the lower-layer signaling later than the time threshold, the IAB node may treat the signal/channel as Dynamic-D (for downlink) or Dynamic-U (for uplink).

In this realization, the time threshold may be determined, according to a standard specification or a network configuration, based on an occurrence of the configured signal/channel activated or triggered by the lower-layer signaling is received. For example, the time threshold may be determined N OFDM symbols prior to the occurrence of the signal/channel as activated or triggered by the lower-layer signaling. Then, if the lower-layer signaling is received no later than the time threshold, the occurrence of the signal/channel is treated as RRC-D or RRC-U. Otherwise, if the lower-layer signaling is received later than the time threshold, the occurrence may be treated as Dynamic-D or Dynamic-U.

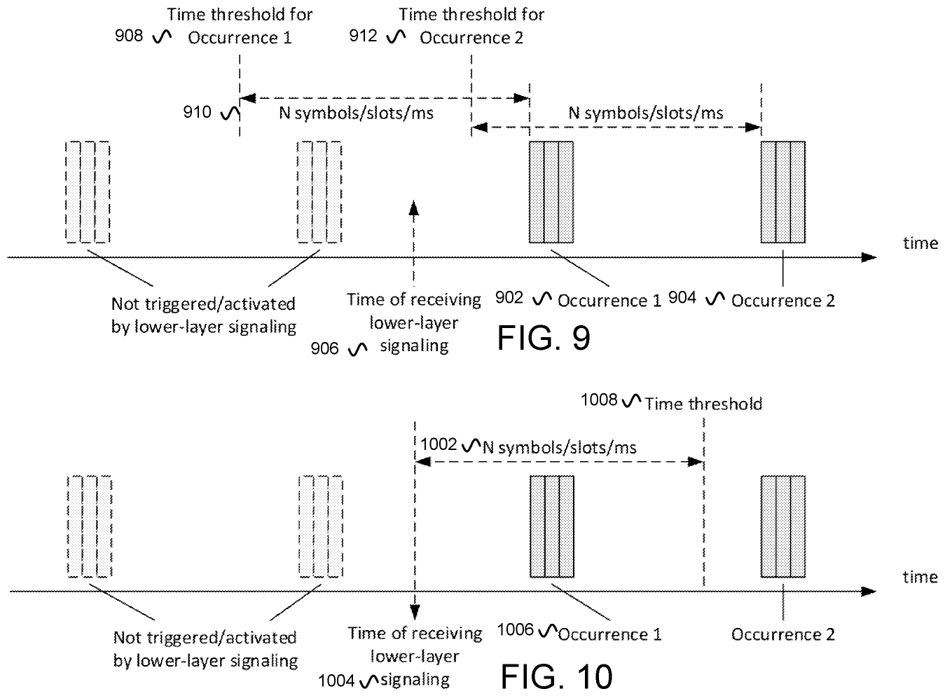

An illustration of this example is shown in FIG. 9. In this example, an occurrence 1 902 and an occurrence 2 904 of a configured signal/channel are activated/triggered by a lower-layer signaling such as a MAC message or a DCI message from a parent node. The time 906 when the IAB node receives the lower-layer signaling is later than the time threshold for occurrence 1 908, which may be N OFDM symbols 910 earlier than the first symbol of occurrence 1 902 of the signal/channel. Therefore, the IAB node treats occurrence 1 902 as Dynamic-D (if the signal/channel is configured for downlink) or Dynamic-U (if the signal/channel is configured for uplink). However, the time 906 when the IAB node receives the lower-layer signaling is not later than a time threshold for occurrence 2 912. Therefore, the IAB node may treat occurrence 2 904 as RRC-D or RRC-U.

N may depend on a capability of the IAB node, specified by the standard, and/or configured by the network. A value of N may be specified or configured in reference to an OFDM numerology or a SCS.

Another way of describing this example, which may lead to a same result, is that any occurrence of the configured signal/channel earlier than a time threshold may be treated as Dynamic-D or Dynamic-U, wherein the time threshold is N OFDM symbols later than the time that the lower-layer signaling is received by the IAB node. Then, any occurrence of the signal/channel (activated or triggered by the lower-layer signaling) later than the time threshold may be treated as RRC-D or DDC-U. An illustration of this alternative description is shown in FIG. 10.

In FIG. 10, N OFDM symbols 1002 after the time 1004 of receiving lower-layer signaling is determined a time threshold by the IAB node. A first symbol of occurrence 1 1006 of the signal/channel, which is activated/triggered by the lower signaling, occurs earlier than the time threshold and, therefore, treated by the IAB node as Dynamic-D or Dynamic-U. However, a first symbol of occurrence 2 of the signal/channel occurs later than the time threshold 1008 and, therefore, is treated by the IAB node as RRC-D or RRC-U. This alternative description may lead to a similar behavior by the IAB node, and hence, either of the descriptions may be adopted for the standard specifications.

As another example, the time threshold may be determined N slots prior to the slot in which a first symbol of the earliest occurrence of the configured signal/channel after the lower-layer signaling is received. N may depend on a capability of the IAB node, specified by the standard, and/or configured by the network. N may be specified or configured in reference to an OFDM numerology or SCS.

As an alternative description for this example, any occurrence of the configured signal/channel in a slot that is earlier than a time threshold slot may be treated as Dynamic-D or Dynamic-U, wherein the time threshold slot is N slots later than the slot in which the lower-layer signaling is received by the IAB node. Then, any occurrence of the signal/channel (activated or triggered by the lower-layer signaling) later than the time threshold slot may be treated as RRC-D or DDC-U.

As yet another example, the time threshold may be specified or configured in a unit of time, such as milliseconds, prior to the earliest occurrence of the configured signal/channel after the lower-layer signaling is received.

As an alternative description for this example, any occurrence of the configured signal/channel that is earlier than a time threshold may be treated as Dynamic-D or Dynamic-U, wherein the time threshold is N milliseconds later than the time at which the lower-layer signaling is received by the IAB node. Then, any occurrence of the signal/channel (activated or triggered by the lower-layer signaling) later than the time threshold may be treated as RRC-D or DDC-U.

A factor for determining a time threshold, such as a value of N symbols/slots/ms may be a timing parameter associated with one of the conflicting signals/channels. For example, if a conflicting signal/channel is a shared channel scheduled by a DCI message, a value of N may be determined based on a scheduling offset parameter such as K0 or K2 (e.g., see [TS 38.214]) associated with the shared channel.

In one variation of this realization, a higher-layer signaling may include an RRC IE or a MAC message, while a lower-layer signaling may include an L1 signaling such as a DCI message or a UCI message. In another realization, a higher-layer signaling may include an RRC IE, while a lower-layer signaling may include a MAC message or an L1 signaling, such as a DCI message or a UCI message.

It should be noted that, in standard specification language, such a rule may be specified as an IAB node “not expecting” to receive a lower-layer signaling later than a threshold, or alternatively, an IAB node receiving a lower-layer signaling later than a threshold may treat be “allowed to neglect” the signal/channel or an occurrence of the signal/channel.

In an alternative realization of this embodiment, an IAB node may not expect to receive a lower-layer signaling activating or triggering a configured signal/channel later than a time threshold, wherein the time threshold may be determined by a similar method as one of the examples for the previous realization.

In yet another realization, an IAB node receiving a lower-layer signaling that activates or triggers a configured signal/channel may be allowed to neglect an occurrence of the signal/channel that occurs earlier than a time threshold, wherein the time threshold may be determined by a similar method as one of the above examples for a realization proposed earlier.

In yet another embodiment, an IAB node may not expect to receive a lower-layer signaling activating or triggering a configured signal/channel if the activation or triggering may result in a DL-UL conflict. According to this embodiment, the network may make sure that a DL-UL conflict for a configured signal/channel may occur at a dually-connected IAB node if the signal/channel is not activated, deactivated, triggered, or otherwise altered by a lower-layer signaling, for example from a parent node.

This embodiment may demand that an IAB-CU ensures that a semi-persistent or aperiodic signal/channel configured for communication with a first parent node of the IAB node does not cause a DL-UL conflict with another signal/channel configured for communication with a second parent node of the IAB node.

In the case of inter-donor DC, e.g., when a first parent node of an IAB node is configured by a first IAB-CU and a second parent node of the IAB node is configured by a second IAB-CU, this embodiment may demand that the IAB-CUs communicate information of signal/channel configurations, e.g., over an Xn interface, in order to ensure that a DL-UL conflict with a semi-persistent or aperiodic signal/channel does not occur at the IAB node.

In yet another embodiment, an IAB node may expect to receive a lower-layer signaling that activates/deactivates or triggers a configured signal/channel provided that the parent node transmitting the lower-layer signaling is a master node (“MN”).

In yet another embodiment, an IAB node may expect to receive a lower-layer signaling that activates/deactivates or triggers a configured signal/channel provided that the parent node transmitting the lower-layer signaling is configured by a same IAB-CU that also configures the IAB node.

Regarding considerations for multiple-MT IAB nodes, an IAB node may comprise one or multiple IAB-MTs. The multiple IAB-MTs may be connected to one parent node. Alternatively, multiple IAB-MTs may be connected to multiple parent nodes, e.g., in a DC scenario. For example, an IAB node may comprise at least two IAB-MTs, wherein a first IAB-MT is connected to a first parent node and a second IAB-MT is connected to second parent node. IAB-MTs of an IAB node may exchange data with each other and with one or multiple IAB-DUs of the IAB node, hence improving robustness and load balancing through topology redundancy among other performance benefits. In general, each of multiple IAB-MTs of an IAB node may be served by one or multiple cells.

Consider the scenario wherein an IAB node comprises a first IAB-MT served by a first cell of a first parent node and a second IAB-MT served by a second cell of a second parent node. The cells may share resources in time, frequency, and/or spatial domains. In particular, in the intra-carrier or intra-band scenarios, a same antenna panel connected to a same RF chain may be used for communications of both IAB-MTs. In this scenario, although frequency resources may not be shared among IAB-MTs, a DL-UL conflicts may occur when the first IAB-MT is scheduled to transmit a UL signal on the first cell while the second IAB-MT is scheduled to receive a DL signaling from the second cell, or vice versa. Methods are proposed for performing conflict resolution in this scenario.

In an embodiment, the IAB node may not expect to perform conflict resolution across its IAB-MTs. Therefore:
in the case of intra-donor DC, the IAB-CU may ensure that DL-UL conflicts do not occur at the multiple-MT IAB node by appropriate configurations such as TDD-UL-DL resource configurations, reference signal configurations, channel configurations, and so on;
in the case of inter-donor DC, the IAB-CUs may communicate configuration information, e.g. over an Xn interface, to ensure that a DL-UL conflict does not occur at the multiple-MT IAB node.

This embodiment may be realized upon a capability signaling whereby the IAB node indicates to an IAB-CU that it does not support a capability of DL-UL conflict resolution, DL-UL collision handling, or the like.

In another embodiment, the IAB node may determine a reference ‘IAB-MT’, which may be the first IAB-MT or the second IAB-MT. This determining may be up to the IAB node implementation or may be based on a standard specification or a network configuration. Then, the IAB node may determine which of the first cell and the second is Cell-I based on which cell is serving the reference IAB-MT. For example, if IAB determines that the first IAB-MT is the reference IAB-MT, then it determines that the first cell is Cell-I.

In yet another embodiment, the IAB node may determine a reference ‘IAB-MT’ as explained above, but the information from the determining may be applied differently. For example, in any conflict resolution, the IAB node may determine a cell serving the reference IAB-MT as Cell-I.

Each of these embodiments may be used individually or in combination with other criteria for determining Cell-I such as the methods proposed earlier.

The said scenario with two IAB-MTs each connected to one serving cell of one parent node was considered as one example. The above methods may be extended to DC scenarios with a larger number of IAB-MTs, a larger number of serving cells, a larger number of parent nodes, IAB-MTs served by multiple serving cells, and so on.

In an embodiment, an IAB node comprises multiple IAB-MTs. The IAB node may assign each IAB-MT, according to an implementation or a configuration, an identifier (“ID”). The IDs may be used for conflict resolution and/or prioritization in the case of DL-UL conflicts. For example, an IAB-MT with a lowest ID may be determined a ‘reference IAB-MT’, and then the IAB node may determine whether cell is Cell-I based on whether the cell is serving the reference IAB-MT.

Regarding RAN3 signaling and inter-donor coordination, in several embodiments of the methods proposed in the present disclosure, it is proposed to that two or multiple IAB-CUs or IAB donors communicate information of configurations, e.g., over an Xn interface. Examples of the configurations are TDD-UL-DL resource configurations (for example from RRC), intended TDD-UL-DL configurations, reference signal configurations (e.g., SS/PBCH blocks, CSI-RS, and SRS), measurement configurations (e.g., SMTC), channel configurations (e.g., SPS and CG-PUSCH), and the like.

In an embodiment, an IAB node may not expect to experience a DL-UL conflict on multiple cells.

In another embodiment, an IAB node may not expect to experience a DL-UL conflict on cells that are provided by a same parent node. The IAB node may perform conflict resolution among cells that are provided by different parent nodes.

In yet another embodiment, an IAB node may not expect to experience a DL-UL conflict on cells that are provided by parent nodes that are configured by a same IAB-CU or IAB donor. The IAB node may perform conflict resolution among cells that are provided by parent nodes that are configured different IAB-CUs or IAB donors.

In one realization of this embodiment, the IAB node may determine whether a cell is Cell-I based on determining whether the cell provided by a parent node that is configured by a specific IAB-CU or IAB donor, for example by the IAB-CU or IAB donor that configures the IAB node, or by the IAB-CU or IAB donor that configures the IAB system comprising the IAB node.

In yet another embodiment, in the case of a DL-UL conflict, an IAB node may prioritize DL-UL directions as configured by a first IAB-CU or IAB donor and/or as signaled by a first parent node or a first cell. This embodiment may be extended to cases of multiple cells or multiple parent nodes, wherein:
in one realization, each IAB-CU or IAB donor is assigned an ID, and then the IAB node prioritizes a DL-UL direction as signaled by an IAB-CU or IAB donor with a lowest ID;
in another realization, each parent node is assigned an ID, and then the IAB node prioritizes a DL-UL direction as signaled by parent node with a lowest ID;
in yet another realization, each cell is assigned an ID, and then the IAB node prioritizes a DL-UL direction as signaled by cell with a lowest ID.

In some embodiments, an IAB node served by two or multiple cells may transmit information of semi-static configuration and/or dynamic signaling associated with a first cell on a second cell for the purpose of coordination among parent nodes.

Regarding extension to additional attributes for enhanced duplexing, in order to enable enhanced duplexing in an IAB node, the IAB node may be configured with new or additional resource attributes such as ‘DL+UL’ resources. The IAB node may perform DL and UL operations on a DL+UL resource, either opportunistically based on implementation or assisted by further signaling and rules.

In this subsection, methods are proposed for conflict resolution with DL+UL resources, or resources possessing other such new/additional attribute.

In an embodiment, an IAB node may consider a DL+UL resource as a DL resource or UL resource in order to determine whether a DL-UL conflict occurs. The considering may be based on a direction of communication considered by the IAB node. For example, if the IAB node schedules a DL communication on an occurrence of the resource, the IAB node may consider that occurrence of the resource as DL. Similarly, if the IAB node schedules a UL communication on an occurrence of the resource, the IAB node may consider that occurrence of the resource as UL.

In another embodiment, an IAB node may consider a DL+UL resource both DL and UL in order to determine whether a conflict occurs. Then, the IAB node may perform a conflict resolution according to a method proposed in this disclosure. According to this embodiment, since DL-UL conflicts may routinely occur with DL+UL resources, the conflict resolutions may practically determine which occurrences of a resource may or may not be used. In other words, an IAB-CU may configure an IAB node with DL+UL resources in order to allow the IAB node to use the resources in an opportunistic manner.

In yet another embodiment, an IAB node may not determine that a conflict between a DL+UL resource and another resource.

In yet another embodiment, if an IAB node receives multiple DL+UL resource configurations, if a symbol is configured DL+UL by all the multiple configurations, the IAB node may not determine a conflict. However, it may determine that:
if the symbol is considered DL on one cell, the symbol is considered DL on any other cell associated with one of the multiple configurations;
if the symbol is considered UL on one cell, the symbol is considered UL on any other cell associated with one of the multiple configurations.

Regarding enhancements to resource multiplexing, the following signaling mechanisms in NR allow to communicate DL/UL information of an OFDM symbol to a UE:
Semi-static RRC signaling,
Dynamic slot format indication (SFI) shared by a group of UEs,
Dynamic signaling to schedule a channel for a UE.

In the following sections, we review the combination of above mechanisms for the following four cases:

| | Master Node (MN) | Secondary Node (SN) |
|---|---|---|
| Case # | or Parent Node 1 | or Parent Node 2 |
| Case DC-A | UL-TX | UL-TX |
| Case DC-B | DL-RX | DL-RX |
| Case DC-C | UL-TX | DL-RX |
| Case DC-D | DL-RX | UL-TX |

For each case, several scenarios are identified, and embodiments are proposed for one or multiple IAB-MTs in association with each scenario. The one or multiple IAB-MTs are comprised by an IAB node in a preferred embodiment. If a reference is made to an IAB node, it may be made to the IAB node comprising the IAB-MT(s). If a reference is made to a parent node, it may be made to a parent node serving the IAB-MT(s). If a reference is made to a child node, it may be made to a child node (or UE or enhanced UE) served by an IAB-DU of an IAB node that comprises the IAB-MT(s).

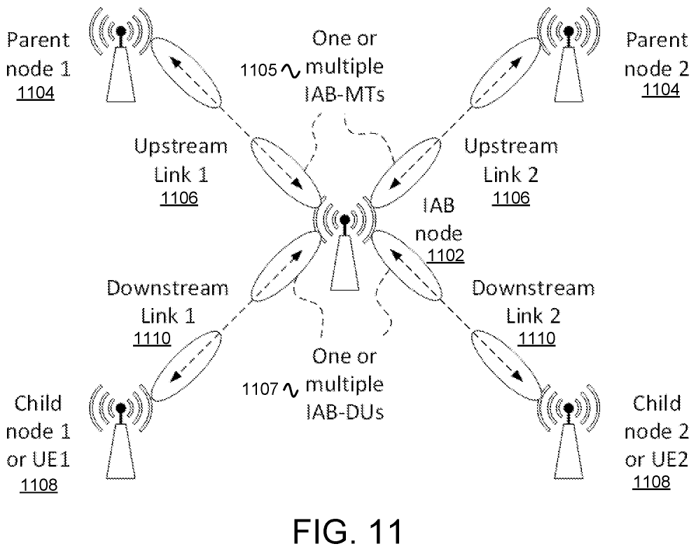

FIG. 11 illustrates the relationship between an IAB node 1102 comprising one or multiple IAB-MTs 1105 connected to one or multiple parent nodes 1104. A link between the parent node 1104 and the IAB-MT 1105 may be referred to as the upstream link 1106, while the link between an IAB-DU 1107 and the child node or UE 1108 may be referred to as the downstream link 1110.

In the descriptions, configurations or signaling for one or multiple IAB-MTs are mentioned. In each case, the configuration or signaling may be received by the IAB node from an IAB-CU on an F1 interface, or from a parent node serving the IAB node on a physical control channel or by a MAC message. For example, when the description reads “an IAB-MT is configured by a resource configuration,” it means the IAB node comprising the IAB-MT has received the resource configuration for the IAB-MT.

In each embodiment, SDM may refer to a scenario where same or different time-frequency resources are used for multiple operations that are multiplexed in the spatial domain, e.g., by multiple antenna panels and/or multiple beams. In each embodiment, FDM may refer to a scenario where different frequency resources are used for multiple operations that may or may not be multiplexed in time and/or spatial domains. The focus of these embodiments is reusing time resources, although TDM is not precluded, possibly in combination with SDM and/or FDM. As such, combination of SDM and FDM and possible combination with other multiplexing schemes such as CDM is not precluded.

In some embodiments, SDM may refer multi-panel operation where multiple antennas, antenna panels, antenna ports, etc. may be used for multiplexing communications.

In the descriptions, the IE names TDD-UL-DL-ConfigCommon and TDD-UL-DL-ConfigDedicated may be abbreviated as ConfigCommon and Config Dedicated, respectively. As an alternative, ConfigCommon and ConfigDedicated may refer to any common and dedicated configuration of resources, respectively. In the descriptions of the methods proposed in this disclosure, the existing RRC IE TDD-UL-DL-ConfigDedicated-IAB-MT-r16 may also be referred to as ConfigDeidcated. Furthermore, new RRC IEs are introduced, which may be called TDD-UL-DL-ConfigDedicated2-r17 or TDD-UL-DL-ConfigDedicated2-IAB-MT-r17, for example. These IEs are abbreviated as ConfigDeidcated2 without an emphasis on what the IEs may be called in the standard specifications for future enhancements.

In the descriptions, a multiplexing scheme may be emphasized in a round bracket, e.g., (SDM), (FDM), (SDM/FDM), and so on. That emphasizes that an embodiment, feature, condition, constraint, etc. may be applicable to a particular multiplexing scheme in some implementations. However, that does not preclude applicability of the embodiment, feature, condition, constraint, etc. to other multiplexing schemes. For example, an embodiment marked with FDM may be applicable to FDM as well as individually (SDM, TDM, CDM, etc.) or in combination with FDM (SDM/FDM, TDM/FDM, CDM/FDM, etc.).

In this disclosure, reference is frequently made to TOL resources such as TOL symbols, although the standard specification may use a different term for overlapping resources For example, the standard may refer to “same” resources, resources that “overlap” in the time-domain, resources that have a symbol or slot in common (fully or partially), and the like.

One reason for defining TOL resources is to clarify that they may be defined or configured for different entities, such as different IAB nodes (such as different parent nodes), an IAB-MT and IAB-DU of an IAB node, multiple IAB-MTs of an IAB node, multiple IAB-DUs of an IAB node (such as a parent node), and the like. Another reason is to cover cases with different numerologies where a symbol in a first operation/configuration may not have the same length in time as a symbol in a second operation/configuration. Yet another reason is to cover cases that a timing misalignment, whether deliberate due to employing different timing alignments or due to an error. TOL resources will be described later in the next sections.

It should be noted that TOL as a relationship between two resources may be commutative—if a first resource/symbol A is time-overlapping with a second resource/symbol B, then B is also TOL with A. Description of the embodiments often make references to a symbol in a first operation/configuration and a TOL symbol in a second operation/configuration.

In the descriptions of embodiments in this disclosure, an “operation” may refer to a transmission (TX) of a signal or a reception (RX) of signal. In this context, a simultaneous operation may refer to simultaneous transmissions, simultaneous receptions, or simultaneous transmissions and receptions by two communication entities. In preferred embodiments, the two entities may belong to a same node such as an IAB node such as multiple IAB-MTs of an IAB node.

Finally, although embodiments are described for symbols, such as OFDM symbols, as a unit of time resources, the methods can be extended to other units such as slots, mini-slots, subframes, a group of symbols such as all the DL, UL, or F symbols in a slot or a group of slots, and so on. Furthermore, the methods may be extended to the frequency domain (with a unit of resource element, resource block, sub-channel, etc.) or other domains.

Regarding the case DC-A, the following table summarizes the different combinations for simultaneous UL-TX1 to a first parent node (e.g., MN) and UL-TX2 to a second parent node (e.g., SN).

| | IAB-DU | | IAB-DU | | |
|---|---|---|---|---|---|
| | configured UL by | IAB-DU | configured | IAB-DU | IAB-DU |
| | Config Common or | indicating | PUCCH, | scheduling | configured |
| | ConfigDedicated | UL by SFI | UL-RS | PUSCH | CG-PUSCH |
| IAB-MT | DC-A-1-1 | DC-A-1-2 | DC-A-1-3 | DC-A-1-4 | DC-A-1-5 |
| configured UL by | | | | | |
| ConfigCommon or | | | | | |
| ConfigDedicated | | | | | |
| IAB-MT indicated | DC-A-2-1 | DC-A-2-2 | DC-A-2-3 | DC-A-2-4 | DC-A-2-5 |
| UL by SFI | | | | | |
| IAB-MT configured | DC-A-3-1 | DC-A-3-2 | DC-A-3-3 | DC-A-3-4 | DC-A-3-5 |
| PUCCH, UL-RS | | | | | |
| IAB-MT scheduled | DC-A-4-1 | DC-A-4-2 | DC-A-4-3 | DC-A-4-4 | DC-A-4-5 |
| PUSCH | | | | | |
| IAB-MT configured | DC-A-5-1 | DC-A-5-2 | DC-A-5-3 | DC-A-5-4 | DC-A-5-5 |
| CG-PUSCH | | | | | |

In this section, references are made to the following recurring phrases.

Simultaneous TX capability: This may refer to an IAB node's capability to perform simultaneous transmissions, which may indicate that the IAB node is capable of SDM and/or FDM, the IAB node has multiple antenna panels (SDM), the IAB node is capable of simultaneous transmissions in DL and UL, the IAB node is capable of enhanced duplexing, or a like. In the case of configuration-based methods, information of the capability may be sent to an IAB-CU that configures the system. In the case of methods based on control signaling, the information of the capability may be sent to another IAB node such as a parent node or a child node.

Power imbalance constraint: This may refer to a constraint according to which the difference between a TX powers for UL-TX1 and a UL-TX2 is not larger than a threshold. The threshold may be determined by an IAB node capability that specifies a maximum power imbalance on one panel (FDM) or among multiple panels (SDM). In the case of configuration-based methods, a power imbalance constraint may be satisfied by semi-static configuration of TX powers. In the case of methods based on control signaling, a TX power for an IAB-MT TX may be determined by a parent node serving the IAB-MT. Therefore, a power imbalance constraint may require an IAB node to adjust a TX power for another IAB-MT TX, if possible, or decline a transmission otherwise.

Total power constraint: This may refer to a constraint according to which the total TX power for UL-TX1 and UL-TX2 does not exceed a threshold. The threshold may be determined by an IAB node capability that specifies a maximum total power for a panel (FDM) or for the IAB node (SDM), by a regulatory limit, or a like. In the case of configuration-based methods, a total power constraint may be satisfied by semi-static configuration of TX powers. In the case of methods based on control signaling, a TX power for an IAB-MT TX may be determined by a parent node serving the IAB-MT. Therefore, a total power constraint may require an IAB node to adjust a TX power for another IAB-MT TX, if possible, or decline a transmission otherwise.

Interference constraint: This may refer to a variety of interference constraints between antennas of an IAB node (self-interference), interference on other nodes or channels or cells, and so on. In some embodiments, according to an interference constraint, the interference by an IAB-MT TX on a parent node should be below a threshold when the parent node performs beamforming for receiving a signal from another IAB-MT TX.

Guard band constraint: This may refer to a constraint according to which the frequency resources (e.g., PRBs) allocated to IAB-MT UL-TX1 is separated from the frequency resources allocated to IAB-MT UL-TX2 by at least a threshold called a guard band. A value of the guard band may be determined by an IAB node capability for one panel (FDM) or among multiple panels (SDM). In the case of configuration-based methods, a resource may be allocated by a configuration. In the case of methods based on control signaling, a resource may be allocated by control message such as an L1/L2 message.

Spatial constraint (FDM): This may refer to a constraint according to which a beam (spatial filter) for transmitting a signal is constrained by a beam (spatial filter) for transmitting another signal. A common case for this constraint is when one or multiple antenna panels are controlled by a same circuitry for controlling beamforming. In this case, if the one or multiple panels are beamformed to transmit a first signal in a particular direction in the spatial domain, any second signal may be constrained to be transmitted with a same beamforming configuration if the same one or multiple panels is to be used. Whether a spatial constraint applies to an IAB node or an antenna panel of an IAB node may be determined by a capability of the IAB node, which may be communicated to an IAB-CU (in the case of configuration-based methods) or another IAB node such as a parent node or a child node (in the case of methods based on control signaling).

Timing alignment constraint (FDM): This constraint may be applicable if the antenna panel is connected to a baseband processor with one DFT/IDFT window. In this case, the timing for two or multiple IAB-MT TXs should be aligned at least at a symbol level. The timing alignment may correspond to a scheme similar to a Case-6 timing scheme as specified by the standard, configured by the network, signaled by a parent node, and so on.

Modifications from A-x-y embodiments (described in PCT application no. PCT/IB2022/050156 entitled “Resource Configuration for Wireless Communication” and filed on Jan. 10, 2022, for Majid Ghanbarinejad, et al., which is incorporated herein by reference [hereinafter “'050156 application”]) include:

| Original for Embodiment A-x-y (in “’050156 | |
|---|---|
| application”) | Modified for Embodiment DC-A-x-y |
| a downlink transmission by an IAB-DU of an | an uplink transmission by an IAB-MT of the |
| IAB node | IAB node |
| a child node communicating with the IAB | a parent node such as a secondary parent node |
| node | serving the IAB node |
| an IAB-MT of the child node | an IAB-DU of the parent node |
| a CSI-RS on the original link between the | an SRS on the new link between the IAB |
| IAB node and the child node | node and the parent node |
| a PDCCH on a CORESET on the original link | a PUCCH on the new link between the IAB |
| between the IAB node and the child node | node and the parent node |
| a PDSCH on the original link between the | a PUSCH on the new link between the IAB |
| IAB node and the child node | node and the parent node |
| an SPS on the original link between the IAB | a CG-PUSCH on the new link between the |
| node and the child node | IAB node and the parent node |

Regarding case DC-B, the following table summarizes the different combinations for simultaneous DL-RX1 from a first parent node (e.g., MN) and DL-RX2 from a second parent node (e.g., SN).

| | IAB-DU | | IAB-DU | | |
|---|---|---|---|---|---|
| | configured DL by | IAB-DU | configured | IAB-DU | IAB-DU |
| | ConfigCommon or | indicated | CORESET, | scheduling | configured |
| | ConfigDedicated | DL by SFI | DL-RS | PDSCH | SPS |
| IAB-MT | DC-B-1-1 | DC-B-1-2 | DC-B-1-3 | DC-B-1-4 | DC-B-1-5 |
| configured DL by | | | | | |
| ConfigCommon or | | | | | |
| ConfigDedicated | | | | | |
| IAB-MT indicated | DC-B-2-1 | DC-B-2-2 | DC-B-2-3 | DC-B-2-4 | DC-B-2-5 |
| DL by SFI | | | | | |
| IAB-MT configured | DC-B-3-1 | DC-B-3-2 | DC-B-3-3 | DC-B-3-4 | DC-B-3-5 |
| CORESET, DL-RS | | | | | |
| IAB-MT scheduled | DC-B-4-1 | DC-B-4-2 | DC-B-4-3 | DC-B-4-4 | DC-B-4-5 |
| PDSCH | | | | | |
| IAB-MT configured | DC-B-5-1 | DC-B-5-2 | DC-B-5-3 | DC-B-5-4 | DC-B-5-5 |
| SPS | | | | | |

In this section, references are made to the following recurring phrases.

Simultaneous RX capability: This may refer to an IAB node's capability to perform simultaneous receptions, which may indicate that the IAB node is capable of SDM and/or FDM, the IAB node has multiple antenna panels (SDM), the LAB node is capable of simultaneous receptions in DL and UL, the LAB node is capable of enhanced duplexing, or a like. In the case of configuration-based methods, information of the capability may be sent to an IAB-CU that configures the system. In the case of methods based on control signaling, the information of the capability may be sent to another IAB node such as a parent node or a child node.

Power imbalance constraint: This may refer to a constraint according to which the difference between RX powers for DL-RX1 and DL-RX2 is not larger than a threshold. The threshold may be determined by an IAB node capability that specifies a maximum power imbalance on one panel (FDM) or among multiple panels (SDM). In the case of configuration-based methods, a power imbalance constraint may be satisfied by semi-static configuration of TX powers. In the case of methods based on control signaling, a TX power for a parent node TX may be assisted by signaling from the IAB-MT. Therefore, a power imbalance constraint may require a parent node to adjust a TX power for a parent node TX, if possible, or decline a transmission otherwise. Alternatively, an IAB-MT may need to signal a parent node to adjust its TX power in order to satisfy a power imbalance constraint while the RX power from another parent node serving an IAB-MT is determined or known by the IAB node.

Interference constraint: This may refer to a variety of interference constraints between antennas of an IAB node (self-interference), interference on other nodes or channels or cells, and so on. In some embodiments, according to an interference constraint, the interference by a parent node on an IAB-MT RX should be below a threshold when the IAB-MT performs beamforming for receiving a signal from another parent node.

Guard band constraint: This may refer to a constraint according to which the frequency resources (e.g., PRBs) allocated to IAB-MT DL-RX1 is separated from the frequency resources allocated to IAB-MT DL-RX2 by at least a threshold called a guard band. A value of the guard band may be determined by an IAB node capability for one panel (FDM) or among multiple panels (SDM). In the case of configuration-based methods, a resource may be allocated by a configuration. In the case of methods based on control signaling, a resource may be allocated by control message such as an L1/L2 message.

Spatial constraint (FDM): This may refer to a constraint according to which a beam (spatial filter) for receiving a signal is constrained by a beam (spatial filter) for receiving another signal. A common case for this constraint is when one or multiple antenna panels are controlled by a same circuitry for controlling beamforming. In this case, if the one or multiple panels are beamformed to receive a first signal in a particular direction in the spatial domain, any second signal may be constrained to be received with a same beamforming configuration if the same one or multiple panels is to be used. Whether a spatial constraint applies to an IAB node or an antenna panel of an IAB node may be determined by a capability of the IAB node, which may be communicated to an IAB-CU (in the case of configuration-based methods) or another IAB node such as a parent node or a child node (in the case of methods based on control signaling).

Timing alignment constraint (FDM): This constraint may be applicable if the antenna panel is connected to a baseband processor with one DFT/IDFT window. In this case, the timing for two or multiple IAB-MT RXs should be aligned at least at a symbol level. The timing alignment may correspond to a Case-7 timing scheme as specified by the standard, configured by the network, signaled by a parent node, and so on.

Modifications from B-x-y embodiments (in “'050156 application”) include:

| Original for Embodiment B-x-y (in “’050156 | |
|---|---|
| application”) | Modified for Embodiment DC-B-x-y |
| an uplink reception by an IAB-DU of an IAB | a downlink reception by an IAB-MT of the |
| node | IAB node |
| a child node communicating with the IAB | a parent node such as a secondary parent node |
| node | serving the IAB node |
| an IAB-MT of the child node | an IAB-DU of the parent node |
| an SRS on the original link between the IAB | a CSI-RS on the new link between the IAB |
| node and the child node | node and the parent node |
| a PUCCH on the original link between the | a PDCCH on a CORESET on the new link |
| IAB node and the child node | between the IAB node and the parent node |
| a PUSCH on the original link between the | a PDSCH on the new link between the IAB |
| IAB node and the child node | node and the parent node |
| a CG-PUSCH on the original link between the | an SPS on the new link between the IAB node |
| IAB node and the child node | and the parent node |

Regarding case DC-C, the following table summarizes the different combinations for simultaneous UL-TX to a first parent node (e.g., MN) and DL-RX from a second parent node (e.g., SN).

| | IAB-DU | | IAB-DU | | |
|---|---|---|---|---|---|
| | configured DL by | IAB-DU | configured | IAB-DU | IAB-DU |
| | Config Common or | indicated | CORESET, | scheduling | configured |
| | ConfigDedicated | DL by SFI | DL-RS | PDSCH | SPS |
| IAB-MT | DC-C-1-1 | DC-C-1-2 | DC-C-1-3 | DC-C-1-4 | DC-C-1-5 |
| configured UL by | | | | | |
| ConfigCommon or | | | | | |
| ConfigDedicated | | | | | |
| IAB-MT indicated | DC-C-2-1 | DC-C-2-2 | DC-C-2-3 | DC-C-2-4 | DC-C-2-5 |
| UL by SFI | | | | | |
| IAB-MT configured | DC-C-3-1 | DC-C-3-2 | DC-C-3-3 | DC-C-3-4 | DC-C-3-5 |
| PUCCH, UL-RS | | | | | |
| IAB-MT scheduled | DC-C-4-1 | DC-C-4-2 | DC-C-4-3 | DC-C-4-4 | DC-C-4-5 |
| PUSCH | | | | | |
| IAB-MT configured | DC-C-5-1 | DC-C-5-2 | DC-C-5-3 | DC-C-5-4 | DC-C-5-5 |
| CG-PUSCH | | | | | |

In this section, references are made to the following recurring phrases.

Simultaneous TX/RX capability: This may refer to an IAB node's capability to perform simultaneous transmission and reception, which may indicate that the IAB node is capable of SDM and/or FDM, the IAB node has multiple antenna panels (SDM), the IAB node is capable of simultaneous transmission and reception in DL and UL, the IAB node is capable of enhanced duplexing, or a like. In the case of configuration-based methods, information of the capability may be sent to an IAB-CU that configures the system. In the case of methods based on control signaling, the information of the capability may be sent to another IAB node such as a parent node or a child node.

Interference constraint: This may refer to a variety of interference constraints between antennas of an IAB node (self-interference), interference on other nodes or channels or cells, and so on. In some embodiments, according to an interference constraint, the interference by a first parent node TX on a second parent node RX should be below a threshold when the second parent node performs beamforming for receiving a signal from an IAB-MT. In some embodiments, according to an interference constraint, the interference by an IAB-MT TX on an IAB-MT RX should be below a threshold when the IAB-MT performs beamforming for receiving a signal from the first parent node.

Guard band constraint: This may refer to a constraint according to which the frequency resources (e.g., PRBs) allocated to the IAB-MT TX is separated from the frequency resources allocated to the IAB-MT RX by at least a threshold called a guard band. A value of the guard band may be determined by an IAB node capability for one panel (FDM) or among multiple panels (SDM). In the case of configuration-based methods, a resource may be allocated by a configuration. In the case of methods based on control signaling, a resource may be allocated by control message such as an L1/L2 message.

| Original for Embodiment C-x-y (in “’050156 | |
|---|---|
| application”) | Modified for Embodiment DC-C-x-y |
| an uplink reception by an IAB-DU of an IAB | a downlink reception by an IAB-MT of the |
| node | IAB node |
| a child node communicating with the IAB | a parent node such as a secondary parent node |
| node | serving the IAB node |
| an IAB-MT of the child node | an IAB-DU of the parent node |
| an SRS on the original link between the IAB | a CSI-RS on the new link between the IAB |
| node and the child node | node and the parent node |
| a PUCCH on the original link between the | a PDCCH on a CORESET on the new link |
| IAB node and the child node | between the IAB node and the parent node |
| a PUSCH on the original link between the | a PDSCH on the new link between the IAB |
| IAB node and the child node | node and the parent node |
| a CG-PUSCH on the original link between the | an SPS on the new link between the IAB node |
| IAB node and the child node | and the parent node |

Modifications from C-x-y embodiments (in “'050156 application”) include:

Regarding case DC-D, the following table summarizes the different combinations for simultaneous DL-RX from a first parent node (e.g., MN) and UL-TX to a second parent node (e.g., SN).

| | IAB-DU | | IAB-DU | | |
|---|---|---|---|---|---|
| | configured UL by | IAB-DU | configured | IAB-DU | IAB-DU |
| | Config Common or | indicating | PUCCH, | scheduling | configured |
| | ConfigDedicated | UL by SFI | UL-RS | PUSCH | CG-PUSCH |
| IAB-MT | DC-D-1-1 | DC-D-1-2 | DC-D-1-3 | DC-D-1-4 | DC-D-1-5 |
| configured DL by | | | | | |
| ConfigCommon or | | | | | |
| ConfigDedicated | | | | | |
| IAB-MT indicated | DC-D-2-1 | DC-D-2-2 | DC-D-2-3 | DC-D-2-4 | DC-D-2-5 |
| DL by SFI | | | | | |
| IAB-MT configured | DC-D-3-1 | DC-D-3-2 | DC-D-3-3 | DC-D-3-4 | DC-D-3-5 |
| CORESET, DL-RS | | | | | |
| IAB-MT scheduled | DC-D-4-1 | DC-D-4-2 | DC-D-4-3 | DC-D-4-4 | DC-D-4-5 |
| PDSCH | | | | | |
| IAB-MT configured | DC-D-5-1 | DC-D-5-2 | DC-D-5-3 | DC-D-5-4 | DC-D-5-5 |
| SPS | | | | | |

In this section, references are made to the following recurring phrases.

Simultaneous TX/RX capability: This may refer to an IAB node's capability to perform simultaneous transmission and reception, which may indicate that the LAB node is capable of SDM and/or FDM, the IAB node has multiple antenna panels (SDM), the IAB node is capable of simultaneous transmission and reception in DL and UL, the IAB node is capable of enhanced duplexing, or a like. In the case of configuration-based methods, information of the capability may be sent to an IAB-CU that configures the system. In the case of methods based on control signaling, the information of the capability may be sent to another IAB node such as a parent node or a child node.

Interference constraint: This may refer to a variety of interference constraints between antennas of an IAB node (self-interference), interference on other nodes or channels or cells, and so on. In some embodiments, according to an interference constraint, the interference by a first parent node TX on a second parent node RX should be below a threshold when the second parent node performs beamforming for receiving a signal from an IAB-MT. In some embodiments, according to an interference constraint, the interference by an IAB-MT TX on an IAB-MT RX should be below a threshold when the IAB-MT performs beamforming for receiving a signal from the first parent node.

Guard band constraint: This may refer to a constraint according to which the frequency resources (e.g., PRBs) allocated to the IAB-MT TX is separated from the frequency resources allocated to the IAB-MT RX by at least a threshold called a guard band. A value of the guard band may be determined by an IAB node capability for one panel (FDM) or among multiple panels (SDM). In the case of configuration-based methods, a resource may be allocated by a configuration. In the case of methods based on control signaling, a resource may be allocated by control message such as an L1/L2 message.

Modifications from D-x-v embodiments (in “'050156 application”) include:

| Original for Embodiment D-x-y (in “’050156 | |
|---|---|
| application”) | Modified for Embodiment DC-D-x-y |
| a downlink transmission by an IAB-DU of an | an uplink transmission by an IAB-MT of the |
| IAB node | IAB node |
| a child node communicating with the IAB | a parent node such as a secondary parent node |
| node | serving the IAB node |
| an IAB-MT of the child node | an IAB-DU of the parent node |
| a CSI-RS on the original link between the | an SRS on the new link between the IAB |
| IAB node and the child node | node and the parent node |
| a PDCCH on a CORESET on the original link | a PUCCH on the new link between the IAB |
| between the IAB node and the child node | node and the parent node |
| a PDSCH on the original link between the | a PUSCH on the new link between the IAB |
| IAB node and the child node | node and the parent node |
| an SPS on the original link between the IAB | a CG-PUSCH on the new link between the |
| node and the child node | IAB node and the parent node |

Furthermore, in some embodiments, a new type of resource may be introduced to allow an IAB node to perform simultaneous operation, either based on a best-effort method or otherwise. This type of resource may be called DL+UL, which may or may not be interpreted as a flexible (F) symbol.

In some embodiments, a DL+UL symbol may be realized by introducing a new value in addition to DL, UL, and F. this may require altering the structure of currently specified messages.

In some embodiments, a DL+UL symbol may be realized by separate signaling. An example of the separate signaling is the TDD-UL-DL-ConfigDedicated2-r17 IE as proposed in several embodiments of this disclosure. If such new IE is introduced, it may be treated similarly as ‘TDD-Config’ in the table of scenarios for DL-UL conflict resolution. A similar principle may be adopted to introduce control messages with structures similar to that of SFI, for example.

Configurations and signaling proposed in the present disclosure, especially for enhanced resource multiplexing methods proposed earlier, may comprise parameters indicating a beam applied for a transmission or a reception, a transmission power to apply for a transmission, a timing alignment method applied for a transmission or a reception, and so on. As will be explained later, a beam may refer to a spatial filter for a transmission or a reception by a node on an antenna panel or antenna port.

Beam: A beam may be referred to, in the standard specifications, by a term such as a spatial filter or spatial parameters. A transmission/reception of a signal with a beam may refer to application of a spatial filter (or spatial parameters) similar to that of another transmission/reception of another signal. “Determining” a beam may follow a beamforming training process comprising transmission and/or reception of reference signals by applying different beams and performing measurements on the signals. “Indicating” a beam may refer to transmitting a message to another node, the message comprising information of a beam/spatial filter in the form of a transmission configuration indication (“TCI”) comprising a spatial quasi collocation (“QCL”) or QCL Type D, a spatial relation parameter, or a like.

Power: A transmission power may be determined or indicated by signaling. The signaling may be semi-static such as by an RRC configuration and/or a control message such as a MAC CE message or a DCI/L1 message. Transmission power control may be applied to uplink transmissions, downlink transmissions, or both, which may be determined by the standard, a configuration, and/or a control signaling.

Timing: A timing alignment method may be determined or indicated by signaling. The signaling may be semi-static such as by an RRC configuration and/or a control message such as a MAC CE message or a DCI/L1 message. In some embodiments, a timing alignment method may be determined by a duplexing/multiplexing case. For example, Case A (simultaneous transmission) at a node may automatically trigger a timing alignment mode based on “Case-6” timing alignment, where transmissions are aligned, whereas Case B (simultaneous reception) at a node may automatically trigger a timing alignment mode based on “Case-7” timing alignment, where receptions are aligned. Whether and how a timing alignment method is triggered or applied may be determined by the standard, a configuration, and/or a control signaling.

Configurations in this disclosure may be RRC configurations or higher-layer configurations, as described earlier, which an IAB node (or a UE) may receive from an IAB-CU over an F1 interface. The configurations may comprise parameters for reference signals such as resources allocated for the reference signals, signaling to trigger transmission of a reference signal, beam/spatial relations and transmission power, and so on.

A reference signal for an interference evaluation may be any reference signal based on which a channel quality or interference may be measured. For example, a channel state information reference signal (“CSI-RS”) may be used for downlink, i.e. when interference by an IAB-DU is to be measured, while a sounding reference signal (“SRS”) may be used for uplink, i.e. when interference by an IAB-MT or a UE is to be measured. Other types of reference signals are not precluded. Once a reference signal is transmitted, it can be received by other nodes, e.g. IAB nodes or UEs, to measure a reference signal receive power (“RSRP”), a reference signal reception quality (“RSRQ”), or a like.

An alternative to a reference signal may be any other transmission based on which an interference or a received signal power such as a received signal strength indicator (“RSSI”) may be computed.

Various types of reference signals have been specified for the NR, which can be used as a starting point for realizing methods proposed in this disclosure. In NR, a reference signal may be periodic, semi-persistent, or aperiodic. A periodic reference signal is transmitted as long as the RRC configuration of the reference signal is valid. A semi-persistent reference signal is configured by an RRC IE, but its transmission is controlled by MAC CE signaling. An aperiodic reference signal is configured by an RRC IE, but its transmission is triggered by physical layer/Layer 1 (L1) signaling, e.g., a DCI message. In all those cases, the RRC configuration comprises parameters indicating which resources are allocated to a reference signal, while the additional MAC CE or DCI signaling may further activate/deactivate or trigger a transmission of the reference signal.

In some embodiments, a parent node or another local node may signal to execute one of the methods proposed in the present disclosure based on information such as an IAB node capability, a number of panels, a type of simultaneous operation (which may itself be determined by resource configurations and resource multiplexing), an IAB node mobility, a history of success or failure associated with a type of duplexing/multiplexing, or a like.

The following should be noted throughout the present disclosure.

Although the entities are referred to as IAB nodes, the same methods can be applied to IAB donors, which are the IAB entities connecting the core network to the IAB network, with minimum or zero modifications.

The different steps described for the example embodiments, in the text and in the flowcharts, may be permuted.

Each configuration may be provided by one or multiple configurations in practice. An earlier configuration may provide a subset of parameters while a later configuration may provide another subset of parameters. Alternatively, a later configuration may override values provided by an earlier configuration or a pre-configuration.

A configuration may be provided by a RRC signaling, a MAC signaling, a physical layer signaling such as a DCI message, a combination thereof, or other methods. A configuration may include a pre-configuration or a semi-static configuration provided by the standard, by the vendor, and/or by the network/operator. Each parameter value received through configuration or indication may override previous values for a similar parameter.

Despite frequent references to IAB, the proposed solutions may be applicable to wireless relay nodes and other types of wireless communication entities.

L1/L2 control signaling may refer to control signaling in layer 1 (physical layer) or layer 2 (data link layer). Particularly, an L1/L2 control signaling may refer to an L1 control signaling such as a DCI message or a UCI message, an L2 control signaling such as a MAC message, or a combination thereof. A format and an interpretation of an L1/L2 control signaling may be determined by the standard, a configuration, other control signaling, or a combination thereof.

Any parameter discussed in this disclosure may appear, in practice, as a linear function of that parameter in signaling or specifications.

It was discussed in 3GPP RAN to allow a vendor (manufacturing IAB systems/devices) and an operator (deploying the LAB systems/devices) to negotiate capabilities of the systems/devices. This means that some of the information assumed to need signaling between entities may readily be available to the devices, for example, by storing the information on a memory unit such as a read-only memory (“ROM”), exchanging the information by proprietary signaling methods, providing the information by a (pre)configuration, or otherwise taking the information into account when creating hardware and/or software of the IAB systems/devices or other entities in the network. In this case, methods described in this disclosure that comprise exchanging the information can be extended to similar methods wherein the information is obtained by those said other methods.

Methods and systems proposed for an IAB-MT may be adopted by a UE as well. If a method or system requires a capability that is not supported by a legacy UE, a UE enhanced to possess the capability may be used. In this case, the UE may be referred to as an enhanced UE or an IAB-enhanced UE and may convey its information of its enhanced capability to the network for proper configuration and operation.

In this disclosure, a node or a wireless node may refer to an IAB node, an IAB-DU, an IAB-MT, a UE, a base station, a gNB, a transmit-receive point (“TRP”) or an IAB donor, and so on. The examples embodiments provided with an emphasis on the type of nodes are not meant to limit the scope of the invention.

There is an emphasis in the description of the methods proposed in this disclosure to perform measurements for beam training on reference signals. Alternatively, in some embodiments, a measurement may be performed on resources that are not necessarily configured for reference signals, but rather a node may measure a receive signal power and obtain a receive signal strength indicator (“RSSI”) or the like.

In this disclosure, reference is frequently made to multiplexing cases as they are being discussed in 3GPP for the IAB enhancement work item (“WI”). However, phrases such as Case C or Case D multiplexing are just a matter of nomenclature, which may not directly appear in the standard. Instead, a Case C multiplexing may be identified by an uplink transmission by a node's IAB-MT and an uplink reception by a node's IAB-DU. Similarly, a Case D multiplexing may be identified by a downlink reception by a node's IAB-MT and a downlink transmission by a node's IAB-DU. In general, depending on node capabilities such as multi-panel and/or full-duplex capabilities of an IAB node, one or multiple of the defined multiplexing cases may be operational at a given moment. For example, if an IAB node transmits an uplink signal to parent node while transmitting to and receiving signals from child nodes, the IAB node may be performing Case A and Case C multiplexing simultaneously. It should be, hence, noted that the methods proposed in this disclosure are not bound to specific multiplexing cases. Different steps/elements explained in the proposed methods may be mixed and matched to realize different multiplexing cases without an explicit mention of how the information obtained by measurements and signaling may be used.

In the present disclosure, reference is frequently made to beam indication. In practice, according to a standard specification, a beam indication may refer to an indication of a reference signal by an ID or indicator, a resource associated with a reference signal, a spatial relation information comprising information of a reference signal or a reciprocal of a reference signal (in the case of beam correspondence).

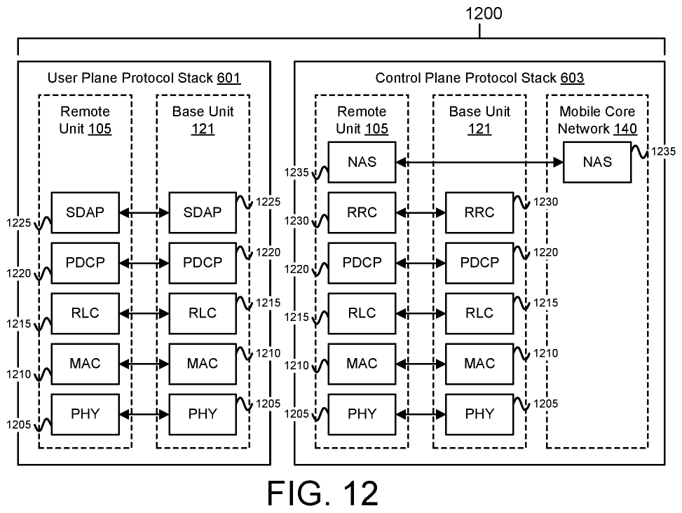

FIG. 12 depicts a NR protocol stack 1200, according to embodiments of the disclosure. While FIG. 12 shows the remote unit 105, the base unit 121 and the mobile core network 130, these are representative of a set of UEs interacting with a RAN node and a NF (e.g., AMF) in a core network. As depicted, the protocol stack 1200 comprises a User Plane protocol stack 1205 and a Control Plane protocol stack 1210. The User Plane protocol stack 1205 includes a physical (“PHY”) layer 1215, a Medium Access Control (“MAC”) sublayer 1220, a Radio Link Control (“RLC”) sublayer 1225, a Packet Data Convergence Protocol (“PDCP”) sublayer 1230, and Service Data Adaptation Protocol (“SDAP”) layer 1235. The Control Plane protocol stack 1210 also includes a physical layer 1215, a MAC sublayer 1220, a RLC sublayer 1225, and a PDCP sublayer 1230. The Control Place protocol stack 1210 also includes a Radio Resource Control (“RRC”) layer and a Non-Access Stratum (“NAS”) layer 645.

The AS protocol stack for the Control Plane protocol stack 1210 consists of at least RRC, PDCP, RLC and MAC sublayers, and the physical layer. The AS protocol stack for the User Plane protocol stack 1205 consists of at least SDAP, PDCP, RLC and MAC sublayers, and the physical layer. The Layer-2 (“L2”) is split into the SDAP, PDCP, RLC and MAC sublayers. The Layer-3 (“L3”) includes the RRC sublayer 640 and the NAS layer 645 for the control plane and includes, e.g., an Internet Protocol (“IP”) layer or PDU Layer (note depicted) for the user plane. L1 and L2 are referred to as “lower layers” such as PUCCH/PUSCH or MAC CE, while L3 and above (e.g., transport layer, application layer) are referred to as “higher layers” or “upper layers” such as RRC.

The physical layer 1215 offers transport channels to the MAC sublayer 1220. The MAC sublayer 1220 offers logical channels to the RLC sublayer 1225. The RLC sublayer 1225 offers RLC channels to the PDCP sublayer 1230. The PDCP sublayer 1230 offers radio bearers to the SDAP sublayer 1235 and/or RRC layer 640. The SDAP sublayer 1235 offers QoS flows to the mobile core network 130 (e.g., 5GC). The RRC layer 640 provides for the addition, modification, and release of Carrier Aggregation and/or Dual Connectivity. The RRC layer 640 also manages the establishment, configuration, maintenance, and release of Signaling Radio Bearers (“SRBs”) and Data Radio Bearers (“DRBs”). In certain embodiments, a RRC entity functions for detection of and recovery from radio link failure.

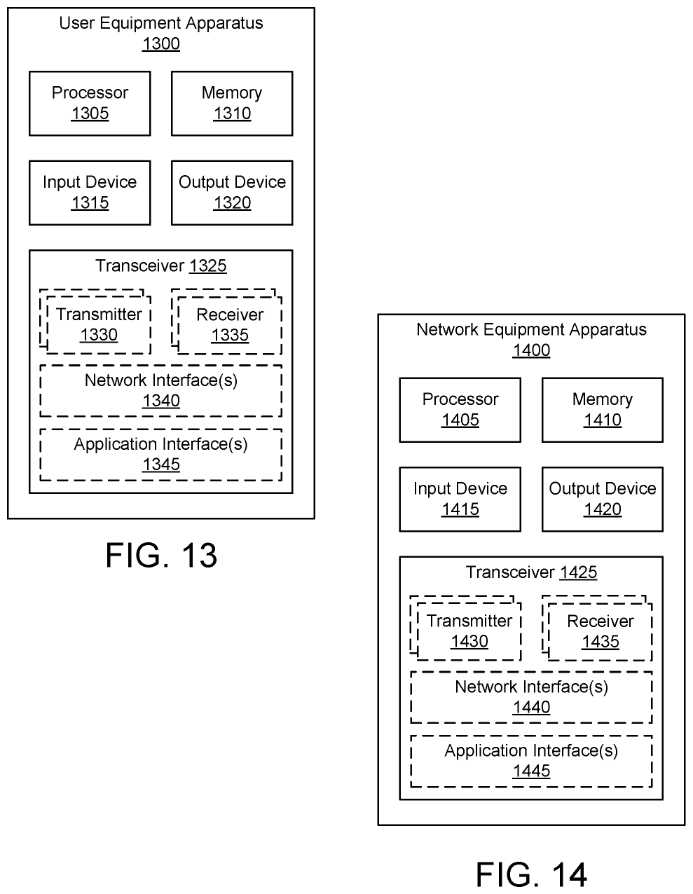

FIG. 13 depicts a user equipment apparatus 1300 that may be used for dual connectivity enhancements in integrated access and backhaul, according to embodiments of the disclosure. In various embodiments, the user equipment apparatus 1300 is used to implement one or more of the solutions described above. The user equipment apparatus 1300 may be one embodiment of a UE, such as the remote unit 105 and/or the UE 205, as described above. Furthermore, the user equipment apparatus 1300 may include a processor 1305, a memory 1310, an input device 1315, an output device 1320, and a transceiver 1325. In some embodiments, the input device 1315 and the output device 1320 are combined into a single device, such as a touchscreen. In certain embodiments, the user equipment apparatus 1300 may not include any input device 1315 and/or output device 1320. In various embodiments, the user equipment apparatus 1300 may include one or more of: the processor 1305, the memory 1310, and the transceiver 1325, and may not include the input device 1315 and/or the output device 1320.

As depicted, the transceiver 1325 includes at least one transmitter 1330 and at least one receiver 1335. Here, the transceiver 1325 communicates with one or more base units 121. Additionally, the transceiver 1325 may support at least one network interface 1340 and/or application interface 1345. The application interface(s) 1345 may support one or more APIs. The network interface(s) 1340 may support 3GPP reference points, such as Uu and PC5. Other network interfaces 1340 may be supported, as understood by one of ordinary skill in the art.

The processor 1305, in one embodiment, may include any known controller capable of executing computer-readable instructions and/or capable of performing logical operations. For example, the processor 1305 may be a microcontroller, a microprocessor, a central processing unit (“CPU”), a graphics processing unit (“GPU”), an auxiliary processing unit, a field programmable gate array (“FPGA”), a digital signal processor (“DSP”), a co-processor, an application-specific processor, or similar programmable controller. In some embodiments, the processor 1305 executes instructions stored in the memory 1310 to perform the methods and routines described herein. The processor 1305 is communicatively coupled to the memory 1310, the input device 1315, the output device 1320, and the transceiver 1325. In certain embodiments, the processor 1305 may include an application processor (also known as “main processor”) which manages application-domain and operating system (“OS”) functions and a baseband processor (also known as “baseband radio processor”) which manages radio functions.

The memory 1310, in one embodiment, is a computer readable storage medium. In some embodiments, the memory 1310 includes volatile computer storage media. For example, the memory 1310 may include a RAM, including dynamic RAM (“DRAM”), synchronous dynamic RAM (“SDRAM”), and/or static RAM (“SRAM”). In some embodiments, the memory 1310 includes non-volatile computer storage media. For example, the memory 1310 may include a hard disk drive, a flash memory, or any other suitable non-volatile computer storage device. In some embodiments, the memory 1310 includes both volatile and non-volatile computer storage media.

In some embodiments, the memory 1310 stores data related to CSI enhancements for higher frequencies. For example, the memory 1310 may store parameters, configurations, resource assignments, policies, and the like as described above. In certain embodiments, the memory 1310 also stores program code and related data, such as an operating system or other controller algorithms operating on the user equipment apparatus 1300, and one or more software applications.

The input device 1315, in one embodiment, may include any known computer input device including a touch panel, a button, a keyboard, a stylus, a microphone, or the like. In some embodiments, the input device 1315 may be integrated with the output device 1320, for example, as a touchscreen or similar touch-sensitive display. In some embodiments, the input device 1315 includes a touchscreen such that text may be input using a virtual keyboard displayed on the touchscreen and/or by handwriting on the touchscreen. In some embodiments, the input device 1315 includes two or more different devices, such as a keyboard and a touch panel.

The output device 1320, in one embodiment, is designed to output visual, audible, and/or haptic signals. In some embodiments, the output device 1320 includes an electronically controllable display or display device capable of outputting visual data to a user. For example, the output device 1320 may include, but is not limited to, an LCD display, an LED display, an OLED display, a projector, or similar display device capable of outputting images, text, or the like to a user. As another, non-limiting, example, the output device 1320 may include a wearable display separate from, but communicatively coupled to, the rest of the user equipment apparatus 1300, such as a smart watch, smart glasses, a heads-up display, or the like. Further, the output device 1320 may be a component of a smart phone, a personal digital assistant, a television, a table computer, a notebook (laptop) computer, a personal computer, a vehicle dashboard, or the like.

In certain embodiments, the output device 1320 includes one or more speakers for producing sound. For example, the output device 1320 may produce an audible alert or notification (e.g., a beep or chime). In some embodiments, the output device 1320 includes one or more haptic devices for producing vibrations, motion, or other haptic feedback. In some embodiments, all or portions of the output device 1320 may be integrated with the input device 1315. For example, the input device 1315 and output device 1320 may form a touchscreen or similar touch-sensitive display. In other embodiments, the output device 1320 may be located near the input device 1315.

The transceiver 1325 includes at least transmitter 1330 and at least one receiver 1335. The transceiver 1325 may be used to provide UL communication signals to a base unit 121 and to receive DL communication signals from the base unit 121, as described herein. Similarly, the transceiver 1325 may be used to transmit and receive SL signals (e.g., V2X communication), as described herein. Although only one transmitter 1330 and one receiver 1335 are illustrated, the user equipment apparatus 1300 may have any suitable number of transmitters 1330 and receivers 1335. Further, the transmitter(s) 1330 and the receiver(s) 1335 may be any suitable type of transmitters and receivers. In one embodiment, the transceiver 1325 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 1325, transmitters 1330, and receivers 1335 may be implemented as physically separate components that access a shared hardware resource and/or software resource, such as for example, the network interface 1340.

In various embodiments, one or more transmitters 1330 and/or one or more receivers 1335 may be implemented and/or integrated into a single hardware component, such as a multi-transceiver chip, a system-on-a-chip, an ASIC, or other type of hardware component. In certain embodiments, one or more transmitters 1330 and/or one or more receivers 1335 may be implemented and/or integrated into a multi-chip module. In some embodiments, other components such as the network interface 1340 or other hardware components/circuits may be integrated with any number of transmitters 1330 and/or receivers 1335 into a single chip. In such embodiment, the transmitters 1330 and receivers 1335 may be logically configured as a transceiver 1325 that uses one more common control signals or as modular transmitters 1330 and receivers 1335 implemented in the same hardware chip or in a multi-chip module.

In one embodiment, the transceiver 1325 receives a first attribute associated with a first symbol on a first cell, the first attribute comprising a first downlink or a first uplink value, receives a second attribute associated with a second symbol on a second cell, the second attribute comprising a second downlink or a second uplink value, the second symbol overlapping with the first symbol in a time domain, and receives first information of a first timing alignment for the first cell and second information of a second timing alignment for the second cell.

In one embodiment, the processor 1305 determines which of the first cell and the second cell is a reference cell based on the first information of the first timing alignment and the second information of the second timing alignment, and in response to determining that the first cell is the reference cell, neglects a second operation associated with the second symbol, and in response to determining that the second cell is the reference cell, neglects a first operation associated with the first symbol.

In one embodiment, the processor 1305 determines which of the first cell and the second cell is the reference cell by determining whether the first timing alignment or the second timing alignment is a transmission timing alignment or a reception timing alignment.

In one embodiment, the transceiver 1325 receives at least a first availability indication associated with the first symbol and a second availability indication associated with the second symbol and the processor determines which of the first cell and the second cell is the reference cell based, at least in part, on at least one of the first availability indication and the second availability indication.

In one embodiment, the processor 1305 further determines which of the first cell and the second cell is the reference cell based on a multiplexing capability of the apparatus.

In one embodiment, the multiplexing capability indicates whether the apparatus is capable of time division multiplexing only.

In one embodiment, the multiplexing capability is communicated to at least one of a parent node, an integrated access and backhaul central unit (IAB-CU), or a network configuration entity.

In one embodiment, the processor 1305 further determines which of the first cell and the second cell is the reference cell based on a multi-panel capability.

In one embodiment, the multi-panel capability is communicated to at least one of a parent node, an integrated access and backhaul central unit (IAB-CU), or a network configuration entity.

In one embodiment, the transceiver 1325 receives, from a first base station associated with the first cell, a coordination signaling and transmits the coordination signaling to a second based station associated with the second cell.

In one embodiment, a first base station associated with the first cell and a second based station associated with the second cell communicate coordination signaling over an F1 interface.

In one embodiment, the transceiver 1325 receives a configuration of a first signal, a first direction of the first signal being different than a second direction of a second signal and receives a control message at a first time, the control message being associated with the first signal. In one embodiment, the processor 1405 determines a time threshold, and in response to determining that the first time is not later than the time threshold, considers the first signal as a configured signal, and in response to determining that the first time is later than the time threshold, considers the first signal as a dynamic signal.

In one embodiment, the first direction is an uplink direction and the second direction is a downlink direction.

In one embodiment, the first direction is a downlink direction and the second direction is an uplink direction.

In one embodiment, the first signal is a semi-persistent reference signal and the control message is an activation message.

In one embodiment, the first signal is an aperiodic reference signal, and the control message is a triggering message.

In one embodiment, the first time is a time that a first symbol of the first signal is received and determining the time threshold comprises receiving information of a number of symbols and setting the time threshold equal to the first time minus the number of symbols.

In one embodiment, considering the first signal as a configured signal comprises neglecting at least one of the first signal and the second signal.

In one embodiment, considering the first signal as a configured signal comprises overriding at least one of the first direction and the second direction.

In one embodiment, considering the first signal as a configured signal comprises raising an error case.

In one embodiment, considering the first signal as a dynamic signal comprises neglecting at least one of the first signal and the second signal.

In one embodiment, considering the first signal as a dynamic signal comprises overriding at least one the first direction and the second direction.

In one embodiment, considering the first signal as a dynamic signal comprises raising an error case.

In one embodiment, the transceiver 1325 receives a first attribute associated with a first symbol on a first cell, the first attribute comprising a first downlink or a first uplink value and receives a second attribute associated with a second symbol on a second cell, the second attribute comprising a second downlink or a second uplink value, the second symbol overlapping with the first symbol in a time domain.

In one embodiment, the processor 1305 determines which of the first cell and the second cell is a reference cell, and in response to determining that the first cell is the reference cell, neglects a second operation associated with the second symbol, and in response to determining that the second cell is the reference cell, neglects a first operation associated with the first symbol.

In one embodiment, the processor 1305 determines which of the first cell and the second cell is the reference cell by determining whether a first timing alignment associated with the first symbol or a second timing alignment associated with the second symbol is a transmission timing alignment or a reception timing alignment.

In one embodiment, the processor 1305 determines which of the first cell and the second cell is the reference cell based on at least one of a first quality-of-service parameter associated with the first symbol or a second quality-of-service parameter associated with the second symbol.

In one embodiment, the processor 1305 determines which of the first cell and the second cell is the reference cell based on a plurality of conflict resolution rules and by determining a conflict resolution rule that is strictest among the plurality of the conflict resolution rules.

In one embodiment, the processor 1305 raises an error case upon determining that a plurality of conflict resolution rules are inconsistent.

In one embodiment, the processor 1305 determines which of the first cell and the second cell is the reference cell based on a first subcarrier spacing associated with the first symbol and a second subcarrier spacing associated with the second symbol.

In one embodiment, the processor 1305 determines which of the first cell and the second cell is the reference cell based on a first subcarrier spacing associated with the first cell and a second subcarrier spacing associated with the second cell.

In one embodiment, the transceiver 1325 receives a first attribute associated with a first symbol for a first mobile terminal (“MT”) functionality, the first attribute comprising a first downlink or a first uplink value and receives a second attribute associated with a second symbol for a second MT functionality, the second attribute comprising a second downlink or a second uplink value, the second symbol overlapping with the first symbol in a time domain.

In one embodiment, the processor 1305 determines which of the first MT and the second MT is a reference MT, and in response to determining that the first MT is the reference MT, neglects a second operation associated with the second symbol, and in response to determining that the second MT is the reference MT, neglects a first operation associated with the first symbol.

FIG. 14 depicts one embodiment of a network apparatus 1400 that may be used for dual connectivity enhancements in integrated access and backhaul, according to embodiments of the disclosure. In some embodiments, the network apparatus 1400 may be one embodiment of a RAN node and its supporting hardware, such as the base unit 121 and/or gNB, described above. Furthermore, network apparatus 1400 may include a processor 1405, a memory 1410, an input device 1415, an output device 1420, and a transceiver 1425. In certain embodiments, the network apparatus 1400 does not include any input device 1415 and/or output device 1420.

As depicted, the transceiver 1425 includes at least one transmitter 1430 and at least one receiver 1435. Here, the transceiver 1425 communicates with one or more remote units 105. Additionally, the transceiver 1425 may support at least one network interface 1440 and/or application interface 1445. The application interface(s) 1445 may support one or more APIs. The network interface(s) 1440 may support 3GPP reference points, such as Uu, N1, N2, N3, N5, N6 and/or N7 interfaces. Other network interfaces 1440 may be supported, as understood by one of ordinary skill in the art.

The processor 1405, in one embodiment, may include any known controller capable of executing computer-readable instructions and/or capable of performing logical operations. For example, the processor 1405 may be a microcontroller, a microprocessor, a central processing unit (“CPU”), a graphics processing unit (“GPU”), an auxiliary processing unit, a field programmable gate array (“FPGA”), a digital signal processor (“DSP”), a co-processor, an application-specific processor, or similar programmable controller. In some embodiments, the processor 1405 executes instructions stored in the memory 1410 to perform the methods and routines described herein. The processor 1405 is communicatively coupled to the memory 1410, the input device 1415, the output device 1420, and the transceiver 1425. In certain embodiments, the processor 1405 may include an application processor (also known as “main processor”) which manages application-domain and operating system (“OS”) functions and a baseband processor (also known as “baseband radio processor”) which manages radio function. In various embodiments, the processor 1405 controls the network apparatus 1400 to implement the above described network entity behaviors (e.g., of the gNB) for dual connectivity enhancements in integrated access and backhaul.

The memory 1410, in one embodiment, is a computer readable storage medium. In some embodiments, the memory 1410 includes volatile computer storage media. For example, the memory 1410 may include a RAM, including dynamic RAM (“DRAM”), synchronous dynamic RAM (“SDRAM”), and/or static RAM (“SRAM”). In some embodiments, the memory 1410 includes non-volatile computer storage media. For example, the memory 1410 may include a hard disk drive, a flash memory, or any other suitable non-volatile computer storage device. In some embodiments, the memory 1410 includes both volatile and non-volatile computer storage media.

In some embodiments, the memory 1410 stores data relating to CSI enhancements for higher frequencies. For example, the memory 1410 may store parameters, configurations, resource assignments, policies, and the like as described above. In certain embodiments, the memory 1410 also stores program code and related data, such as an operating system (“OS”) or other controller algorithms operating on the network apparatus 1400, and one or more software applications.

The input device 1415, in one embodiment, may include any known computer input device including a touch panel, a button, a keyboard, a stylus, a microphone, or the like. In some embodiments, the input device 1415 may be integrated with the output device 1420, for example, as a touchscreen or similar touch-sensitive display. In some embodiments, the input device 1415 includes a touchscreen such that text may be input using a virtual keyboard displayed on the touchscreen and/or by handwriting on the touchscreen. In some embodiments, the input device 1415 includes two or more different devices, such as a keyboard and a touch panel.

The output device 1420, in one embodiment, may include any known electronically controllable display or display device. The output device 1420 may be designed to output visual, audible, and/or haptic signals. In some embodiments, the output device 1420 includes an electronic display capable of outputting visual data to a user. Further, the output device 1420 may be a component of a smart phone, a personal digital assistant, a television, a table computer, a notebook (laptop) computer, a personal computer, a vehicle dashboard, or the like.

In certain embodiments, the output device 1420 includes one or more speakers for producing sound. For example, the output device 1420 may produce an audible alert or notification (e.g., a beep or chime). In some embodiments, the output device 1420 includes one or more haptic devices for producing vibrations, motion, or other haptic feedback. In some embodiments, all or portions of the output device 1420 may be integrated with the input device 1415. For example, the input device 1415 and output device 1420 may form a touchscreen or similar touch-sensitive display. In other embodiments, all or portions of the output device 1420 may be located near the input device 1415.

As discussed above, the transceiver 1425 may communicate with one or more remote units and/or with one or more interworking functions that provide access to one or more PLMNs. The transceiver 1425 may also communicate with one or more network functions (e.g., in the mobile core network 80). The transceiver 1425 operates under the control of the processor 1405 to transmit messages, data, and other signals and also to receive messages, data, and other signals. For example, the processor 1405 may selectively activate the transceiver (or portions thereof) at particular times in order to send and receive messages.

The transceiver 1425 may include one or more transmitters 1430 and one or more receivers 1435. In certain embodiments, the one or more transmitters 1430 and/or the one or more receivers 1435 may share transceiver hardware and/or circuitry. For example, the one or more transmitters 1430 and/or the one or more receivers 1435 may share antenna(s), antenna tuner(s), amplifier(s), filter(s), oscillator(s), mixer(s), modulator/demodulator(s), power supply, and the like. In one embodiment, the transceiver 1425 implements multiple logical transceivers using different communication protocols or protocol stacks, while using common physical hardware.

In one embodiment, the transceiver 1425 receives a first attribute associated with a first symbol on a first cell, the first attribute comprising a first downlink or a first uplink value, receives a second attribute associated with a second symbol on a second cell, the second attribute comprising a second downlink or a second uplink value, the second symbol overlapping with the first symbol in a time domain, and receives first information of a first timing alignment for the first cell and second information of a second timing alignment for the second cell.

In one embodiment, the processor 1405 determines which of the first cell and the second cell is a reference cell based on the first information of the first timing alignment and the second information of the second timing alignment, and in response to determining that the first cell is the reference cell, neglects a second operation associated with the second symbol, and in response to determining that the second cell is the reference cell, neglects a first operation associated with the first symbol.

In one embodiment, the processor 1405 determines which of the first cell and the second cell is the reference cell by determining whether the first timing alignment or the second timing alignment is a transmission timing alignment or a reception timing alignment.

In one embodiment, the transceiver 1425 receives at least a first availability indication associated with the first symbol and a second availability indication associated with the second symbol and the processor determines which of the first cell and the second cell is the reference cell based, at least in part, on at least one of the first availability indication and the second availability indication.

In one embodiment, the processor 1405 further determines which of the first cell and the second cell is the reference cell based on a multiplexing capability of the apparatus.

In one embodiment, the multiplexing capability indicates whether the apparatus is capable of time division multiplexing only.

In one embodiment, the multiplexing capability is communicated to at least one of a parent node, an integrated access and backhaul central unit (IAB-CU), or a network configuration entity.

In one embodiment, the processor 1405 further determines which of the first cell and the second cell is the reference cell based on a multi-panel capability.

In one embodiment, the multi-panel capability is communicated to at least one of a parent node, an integrated access and backhaul central unit (IAB-CU), or a network configuration entity.

In one embodiment, the transceiver 1425 receives, from a first base station associated with the first cell, a coordination signaling and transmits the coordination signaling to a second based station associated with the second cell.

In one embodiment, a first base station associated with the first cell and a second based station associated with the second cell communicate coordination signaling over an F1 interface.

In one embodiment, the transceiver 1425 receives a configuration of a first signal, a first direction of the first signal being different than a second direction of a second signal and receives a control message at a first time, the control message being associated with the first signal. In one embodiment, the processor 1405 determines a time threshold, and in response to determining that the first time is not later than the time threshold, considers the first signal as a configured signal, and in response to determining that the first time is later than the time threshold, considers the first signal as a dynamic signal.

In one embodiment, the first direction is an uplink direction and the second direction is a downlink direction.

In one embodiment, the first direction is a downlink direction and the second direction is an uplink direction.

In one embodiment, the first signal is a semi-persistent reference signal and the control message is an activation message.

In one embodiment, the first signal is an aperiodic reference signal, and the control message is a triggering message.

In one embodiment, the first time is a time that a first symbol of the first signal is received and determining the time threshold comprises receiving information of a number of symbols and setting the time threshold equal to the first time minus the number of symbols.

In one embodiment, considering the first signal as a configured signal comprises neglecting at least one of the first signal and the second signal.

In one embodiment, considering the first signal as a configured signal comprises overriding at least one of the first direction and the second direction.

In one embodiment, considering the first signal as a configured signal comprises raising an error case.

In one embodiment, considering the first signal as a dynamic signal comprises neglecting at least one of the first signal and the second signal.

In one embodiment, considering the first signal as a dynamic signal comprises overriding at least one the first direction and the second direction.

In one embodiment, considering the first signal as a dynamic signal comprises raising an error case.

In one embodiment, the transceiver 1425 receives a first attribute associated with a first symbol on a first cell, the first attribute comprising a first downlink or a first uplink value and receives a second attribute associated with a second symbol on a second cell, the second attribute comprising a second downlink or a second uplink value, the second symbol overlapping with the first symbol in a time domain.

In one embodiment, the processor 1405 determines which of the first cell and the second cell is a reference cell, and in response to determining that the first cell is the reference cell, neglects a second operation associated with the second symbol, and in response to determining that the second cell is the reference cell, neglects a first operation associated with the first symbol.

In one embodiment, the processor 1405 determines which of the first cell and the second cell is the reference cell by determining whether a first timing alignment associated with the first symbol or a second timing alignment associated with the second symbol is a transmission timing alignment or a reception timing alignment.

In one embodiment, the processor 1405 determines which of the first cell and the second cell is the reference cell based on at least one of a first quality-of-service parameter associated with the first symbol or a second quality-of-service parameter associated with the second symbol.

In one embodiment, the processor 1405 determines which of the first cell and the second cell is the reference cell based on a plurality of conflict resolution rules and by determining a conflict resolution rule that is strictest among the plurality of the conflict resolution rules.

In one embodiment, the processor 1405 raises an error case upon determining that a plurality of conflict resolution rules are inconsistent.

In one embodiment, the processor 1405 determines which of the first cell and the second cell is the reference cell based on a first subcarrier spacing associated with the first symbol and a second subcarrier spacing associated with the second symbol.

In one embodiment, the processor 1405 determines which of the first cell and the second cell is the reference cell based on a first subcarrier spacing associated with the first cell and a second subcarrier spacing associated with the second cell.

In one embodiment, the transceiver 1425 receives a first attribute associated with a first symbol for a first mobile terminal (“MT”) functionality, the first attribute comprising a first downlink or a first uplink value and receives a second attribute associated with a second symbol for a second MT functionality, the second attribute comprising a second downlink or a second uplink value, the second symbol overlapping with the first symbol in a time domain.

In one embodiment, the processor 1405 determines which of the first MT and the second MT is a reference MT, and in response to determining that the first MT is the reference MT, neglects a second operation associated with the second symbol, and in response to determining that the second MT is the reference MT, neglects a first operation associated with the first symbol.

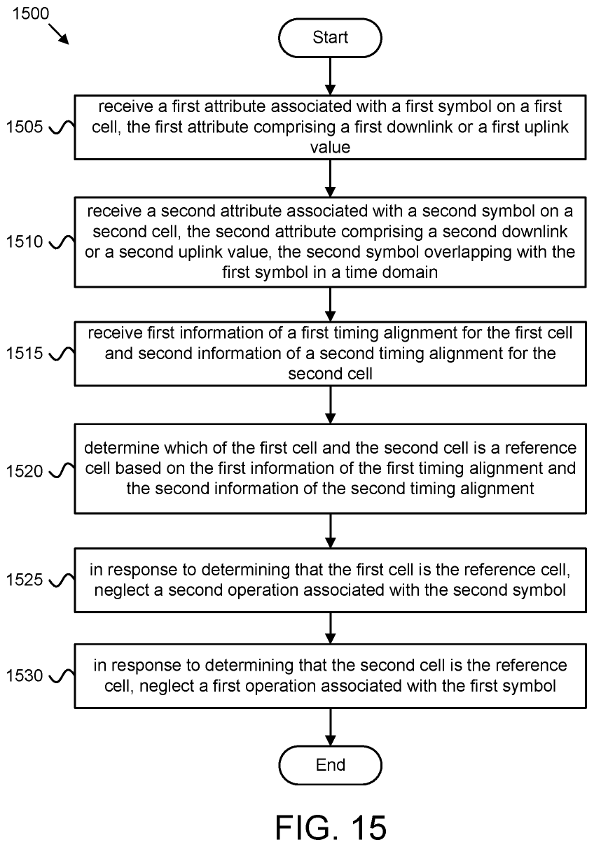

FIG. 15 is a flowchart diagram of a method 1500 for dual connectivity enhancements in integrated access and backhaul. The method 1500 may be performed by a UE as described herein, for example, the remote unit 105 and/or the user equipment apparatus 1300, or a network device such as a base unit 121, a gNB, and/or the network equipment apparatus 1400. In some embodiments, the method 1500 may be performed by a processor executing program code, for example, a microcontroller, a microprocessor, a CPU, a GPU, an auxiliary processing unit, a FPGA, or the like.

In one embodiment, the method 1500 begins and receives 1505 a first attribute associated with a first symbol on a first cell, the first attribute comprising a first downlink or a first uplink value. In one embodiment, the method 1500 receives 1510 a second attribute associated with a second symbol on a second cell, the second attribute comprising a second downlink or a second uplink value, the second symbol overlapping with the first symbol in a time domain.

In one embodiment, the method 1500 receives 1515 first information of a first timing alignment for the first cell and second information of a second timing alignment for the second cell. In one embodiment, the method 1500 determines 1520 which of the first cell and the second cell is a reference cell based on the first information of the first timing alignment and the second information of the second timing alignment.

In one embodiment, the method 1500, in response to determining that the first cell is the reference cell, neglects 1525 a second operation associated with the second symbol. In one embodiment, the method 1500, in response to determining that the second cell is the reference cell, neglects 1530 a first operation associated with the first symbol, and the method 1500 ends.

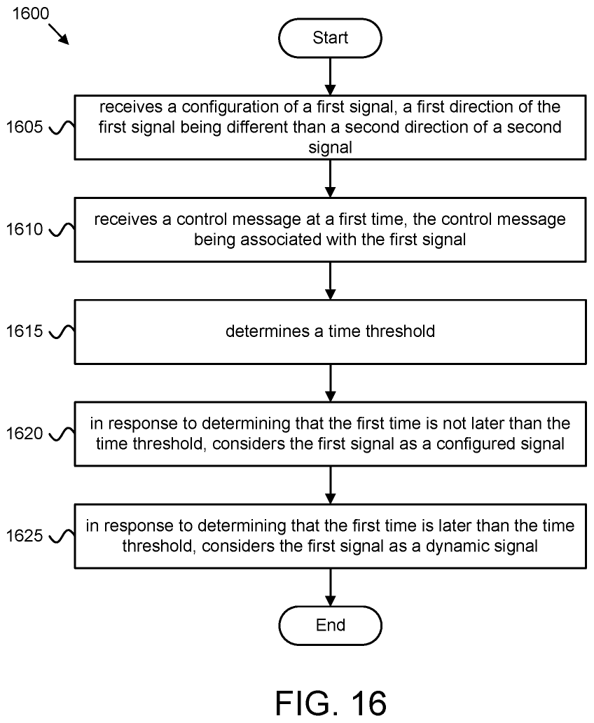

FIG. 16 is a flowchart diagram of a method 1600 for dual connectivity enhancements in integrated access and backhaul. The method 1600 may be performed by a UE as described herein, for example, the remote unit 105 and/or the user equipment apparatus 1300, or a network device such as a base unit 121, a gNB, and/or the network equipment apparatus 1400. In some embodiments, the method 1600 may be performed by a processor executing program code, for example, a microcontroller, a microprocessor, a CPU, a GPU, an auxiliary processing unit, a FPGA, or the like.

In one embodiment, the method 1600 begins and receives 1605 a configuration of a first signal, a first direction of the first signal being different than a second direction of a second signal. In one embodiment, the method 1600 receives 1610 a control message at a first time, the control message being associated with the first signal. In one embodiment, the method 1600 determines 1615 a time threshold. In one embodiment, the method 1600, in response to determining that the first time is not later than the time threshold, considers 1620 the first signal as a configured signal. In one embodiment, the method 1600, in response to determining that the first time is later than the time threshold, considers 1625 the first signal as a dynamic signal, and the method 1600 ends.

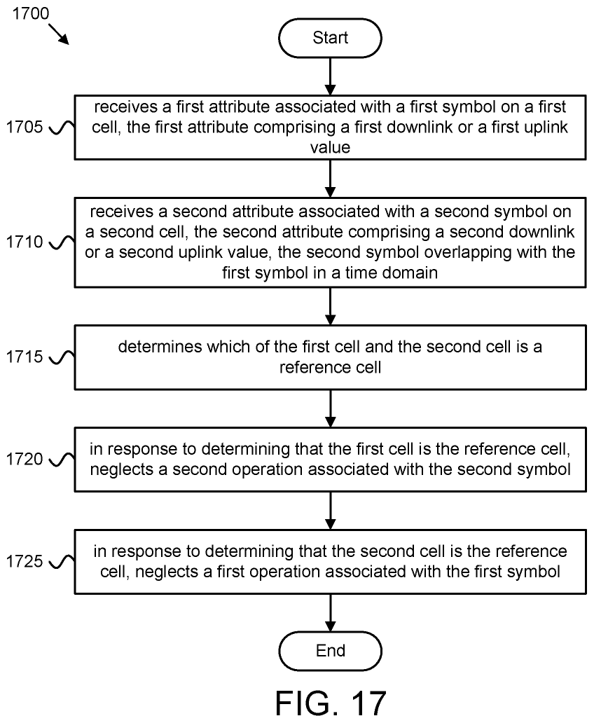

FIG. 17 is a flowchart diagram of a method 1700 for dual connectivity enhancements in integrated access and backhaul. The method 1700 may be performed by a UE as described herein, for example, the remote unit 105 and/or the user equipment apparatus 1300, or a network device such as a base unit 121, a gNB, and/or the network equipment apparatus 1400. In some embodiments, the method 1700 may be performed by a processor executing program code, for example, a microcontroller, a microprocessor, a CPU, a GPU, an auxiliary processing unit, a FPGA, or the like.

In one embodiment, the method 1700 begins and receives 1705 a first attribute associated with a first symbol on a first cell, the first attribute comprising a first downlink or a first uplink value. In one embodiment, the method 1700 receives 1710 a second attribute associated with a second symbol on a second cell, the second attribute comprising a second downlink or a second uplink value, the second symbol overlapping with the first symbol in a time domain.

In one embodiment, the method 1700 determines 1715 which of the first cell and the second cell is a reference cell. In one embodiment, the method 1700, in response to determining that the first cell is the reference cell, neglects 1720 a second operation associated with the second symbol. In one embodiment, the method 1700, in response to determining that the second cell is the reference cell, neglects 1725 a first operation associated with the first symbol, and the method 1700 ends.

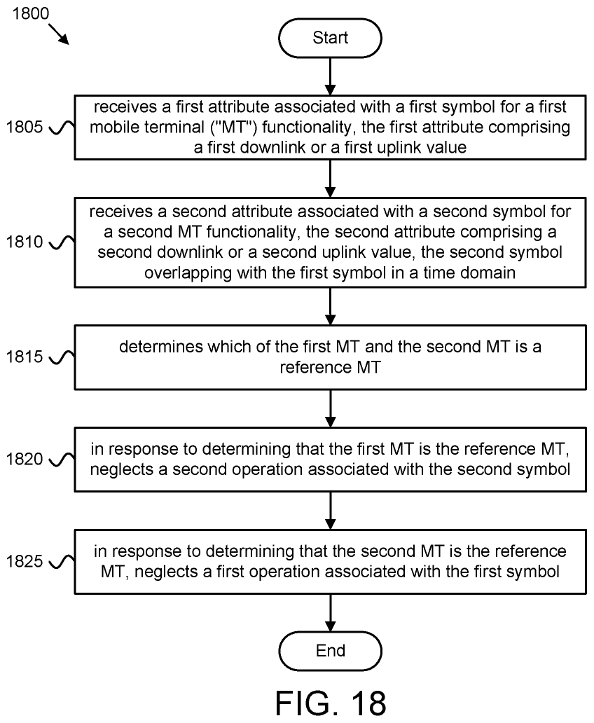

FIG. 18 is a flowchart diagram of a method 1800 for dual connectivity enhancements in integrated access and backhaul. The method 1800 may be performed by a UE as described herein, for example, the remote unit 105 and/or the user equipment apparatus 1300, or a network device such as a base unit 121, a gNB, and/or the network equipment apparatus 1400. In some embodiments, the method 1800 may be performed by a processor executing program code, for example, a microcontroller, a microprocessor, a CPU, a GPU, an auxiliary processing unit, a FPGA, or the like.

In one embodiment, the method 1800 begins and receives 18105 a first attribute associated with a first symbol for a first mobile terminal (“MT”) functionality, the first attribute comprising a first downlink or a first uplink value. In one embodiment, the method 1800 receives a second attribute associated with a second symbol for a second MT functionality, the second attribute comprising a second downlink or a second uplink value, the second symbol overlapping with the first symbol in a time domain.

In one embodiment, the method 1800 determines 1815 which of the first MT and the second MT is a reference MT. In one embodiment, the method 1800, in response to determining that the first MT is the reference MT, neglects 1820 a second operation associated with the second symbol. In one embodiment, the method 1800, in response to determining that the second MT is the reference MT, neglects 1825 a first operation associated with the first symbol, and the method 1800 ends.

A first apparatus is disclosed for dual connectivity enhancements in integrated access and backhaul. The first apparatus may include a UE as described herein, for example, the remote unit 105 and/or the user equipment apparatus 1300, or a network device such as a base unit 121, a gNB, and/or the network equipment apparatus 1400. In some embodiments, the first apparatus includes a processor executing program code, for example, a microcontroller, a microprocessor, a CPU, a GPU, an auxiliary processing unit, a FPGA, or the like.

In one embodiment, the first apparatus includes a transceiver that receives a first attribute associated with a first symbol on a first cell, the first attribute comprising a first downlink or a first uplink value, receives a second attribute associated with a second symbol on a second cell, the second attribute comprising a second downlink or a second uplink value, the second symbol overlapping with the first symbol in a time domain, and receives first information of a first timing alignment for the first cell and second information of a second timing alignment for the second cell.

In one embodiment, the first apparatus includes a processor that determines which of the first cell and the second cell is a reference cell based on the first information of the first timing alignment and the second information of the second timing alignment, and in response to determining that the first cell is the reference cell, neglects a second operation associated with the second symbol, and in response to determining that the second cell is the reference cell, neglects a first operation associated with the first symbol.

In one embodiment, the processor determines which of the first cell and the second cell is the reference cell by determining whether the first timing alignment or the second timing alignment is a transmission timing alignment or a reception timing alignment.

In one embodiment, the transceiver receives at least a first availability indication associated with the first symbol and a second availability indication associated with the second symbol and the processor determines which of the first cell and the second cell is the reference cell based, at least in part, on at least one of the first availability indication and the second availability indication.

In one embodiment, the processor further determines which of the first cell and the second cell is the reference cell based on a multiplexing capability of the apparatus.

In one embodiment, the multiplexing capability indicates whether the apparatus is capable of time division multiplexing only.

In one embodiment, the multiplexing capability is communicated to at least one of a parent node, an integrated access and backhaul central unit (IAB-CU), or a network configuration entity.

In one embodiment, the processor further determines which of the first cell and the second cell is the reference cell based on a multi-panel capability.

In one embodiment, the multi-panel capability is communicated to at least one of a parent node, an integrated access and backhaul central unit (IAB-CU), or a network configuration entity.

In one embodiment, the transceiver receives, from a first base station associated with the first cell, a coordination signaling and transmits the coordination signaling to a second based station associated with the second cell.

In one embodiment, a first base station associated with the first cell and a second based station associated with the second cell communicate coordination signaling over an F1 interface.

A first method is disclosed for dual connectivity enhancements in integrated access and backhaul. The first method may be performed by a UE as described herein, for example, the remote unit 105 and/or the user equipment apparatus 1300, or a network device such as a base unit 121, a gNB, and/or the network equipment apparatus 1400. In some embodiments, the first method may be performed by a processor executing program code, for example, a microcontroller, a microprocessor, a CPU, a GPU, an auxiliary processing unit, a FPGA, or the like.

In one embodiment, the first method receives a first attribute associated with a first symbol on a first cell, the first attribute comprising a first downlink or a first uplink value, receives a second attribute associated with a second symbol on a second cell, the second attribute comprising a second downlink or a second uplink value, the second symbol overlapping with the first symbol in a time domain, and receives first information of a first timing alignment for the first cell and second information of a second timing alignment for the second cell.

In one embodiment, the first method determines which of the first cell and the second cell is a reference cell based on the first information of the first timing alignment and the second information of the second timing alignment, and in response to determining that the first cell is the reference cell, neglects a second operation associated with the second symbol, and in response to determining that the second cell is the reference cell, neglects a first operation associated with the first symbol.

In one embodiment, the first method determines which of the first cell and the second cell is the reference cell by determining whether the first timing alignment or the second timing alignment is a transmission timing alignment or a reception timing alignment.

In one embodiment, the first method receives at least a first availability indication associated with the first symbol and a second availability indication associated with the second symbol and the processor determines which of the first cell and the second cell is the reference cell based, at least in part, on at least one of the first availability indication and the second availability indication.

In one embodiment, the first method further determines which of the first cell and the second cell is the reference cell based on a multiplexing capability of the apparatus.

In one embodiment, the multiplexing capability indicates whether the apparatus is capable of time division multiplexing only.

In one embodiment, the multiplexing capability is communicated to at least one of a parent node, an integrated access and backhaul central unit (IAB-CU), or a network configuration entity.

In one embodiment, the first method further determines which of the first cell and the second cell is the reference cell based on a multi-panel capability.

In one embodiment, the multi-panel capability is communicated to at least one of a parent node, an integrated access and backhaul central unit (IAB-CU), or a network configuration entity.

In one embodiment, the first method receives, from a first base station associated with the first cell, a coordination signaling and transmits the coordination signaling to a second based station associated with the second cell.

In one embodiment, a first base station associated with the first cell and a second based station associated with the second cell communicate coordination signaling over an F1 interface.

A second apparatus is disclosed for dual connectivity enhancements in integrated access and backhaul. The second apparatus may include a UE as described herein, for example, the remote unit 105 and/or the user equipment apparatus 1300, or a network device such as a base unit 121, a gNB, and/or the network equipment apparatus 1400. In some embodiments, the second apparatus includes a processor executing program code, for example, a microcontroller, a microprocessor, a CPU, a GPU, an auxiliary processing unit, a FPGA, or the like.

In one embodiment, the second apparatus includes a transceiver that receives a configuration of a first signal, a first direction of the first signal being different than a second direction of a second signal and receives a control message at a first time, the control message being associated with the first signal. In one embodiment, the second apparatus includes a processor that determines a time threshold, and in response to determining that the first time is not later than the time threshold, considers the first signal as a configured signal, and in response to determining that the first time is later than the time threshold, considers the first signal as a dynamic signal.

In one embodiment, the first direction is an uplink direction and the second direction is a downlink direction.

In one embodiment, the first direction is a downlink direction and the second direction is an uplink direction.

In one embodiment, the first signal is a semi-persistent reference signal and the control message is an activation message.

In one embodiment, the first signal is an aperiodic reference signal, and the control message is a triggering message.

In one embodiment, the first time is a time that a first symbol of the first signal is received and determining the time threshold comprises receiving information of a number of symbols and setting the time threshold equal to the first time minus the number of symbols.

In one embodiment, considering the first signal as a configured signal comprises neglecting at least one of the first signal and the second signal.

In one embodiment, considering the first signal as a configured signal comprises overriding at least one of the first direction and the second direction.

In one embodiment, considering the first signal as a configured signal comprises raising an error case.

In one embodiment, considering the first signal as a dynamic signal comprises neglecting at least one of the first signal and the second signal.

In one embodiment, considering the first signal as a dynamic signal comprises overriding at least one the first direction and the second direction.

In one embodiment, considering the first signal as a dynamic signal comprises raising an error case.

A second method is disclosed for dual connectivity enhancements in integrated access and backhaul. The second method may be performed by a UE as described herein, for example, the remote unit 105 and/or the user equipment apparatus 1300, or a network device such as a base unit 121, a gNB, and/or the network equipment apparatus 1400. In some embodiments, the second method may be performed by a processor executing program code, for example, a microcontroller, a microprocessor, a CPU, a GPU, an auxiliary processing unit, a FPGA, or the like.

In one embodiment, the second method receives a configuration of a first signal, a first direction of the first signal being different than a second direction of a second signal and receives a control message at a first time, the control message being associated with the first signal. In one embodiment, the second method determines a time threshold, and in response to determining that the first time is not later than the time threshold, considers the first signal as a configured signal, and in response to determining that the first time is later than the time threshold, considers the first signal as a dynamic signal.

In one embodiment, the first direction is an uplink direction and the second direction is a downlink direction.

In one embodiment, the first direction is a downlink direction and the second direction is an uplink direction.

In one embodiment, the first signal is a semi-persistent reference signal and the control message is an activation message.

In one embodiment, the first signal is an aperiodic reference signal, and the control message is a triggering message.

In one embodiment, the first time is a time that a first symbol of the first signal is received and determining the time threshold comprises receiving information of a number of symbols and setting the time threshold equal to the first time minus the number of symbols.

In one embodiment, considering the first signal as a configured signal comprises neglecting at least one of the first signal and the second signal.

In one embodiment, considering the first signal as a configured signal comprises overriding at least one of the first direction and the second direction.

In one embodiment, considering the first signal as a configured signal comprises raising an error case.

In one embodiment, considering the first signal as a dynamic signal comprises neglecting at least one of the first signal and the second signal.

In one embodiment, considering the first signal as a dynamic signal comprises overriding at least one the first direction and the second direction.

In one embodiment, considering the first signal as a dynamic signal comprises raising an error case.

A third apparatus is disclosed for dual connectivity enhancements in integrated access and backhaul. The third apparatus may include a UE as described herein, for example, the remote unit 105 and/or the user equipment apparatus 1300, or a network device such as a base unit 121, a gNB, and/or the network equipment apparatus 1400. In some embodiments, the third apparatus includes a processor executing program code, for example, a microcontroller, a microprocessor, a CPU, a GPU, an auxiliary processing unit, a FPGA, or the like.

In one embodiment, the third apparatus includes a transceiver that receives a first attribute associated with a first symbol on a first cell, the first attribute comprising a first downlink or a first uplink value and receives a second attribute associated with a second symbol on a second cell, the second attribute comprising a second downlink or a second uplink value, the second symbol overlapping with the first symbol in a time domain.

In one embodiment, the third apparatus includes a processor that determines which of the first cell and the second cell is a reference cell, and in response to determining that the first cell is the reference cell, neglects a second operation associated with the second symbol, and in response to determining that the second cell is the reference cell, neglects a first operation associated with the first symbol.

In one embodiment, the processor determines which of the first cell and the second cell is the reference cell by determining whether a first timing alignment associated with the first symbol or a second timing alignment associated with the second symbol is a transmission timing alignment or a reception timing alignment.

In one embodiment, the processor determines which of the first cell and the second cell is the reference cell based on at least one of a first quality-of-service parameter associated with the first symbol or a second quality-of-service parameter associated with the second symbol.

In one embodiment, the processor determines which of the first cell and the second cell is the reference cell based on a plurality of conflict resolution rules and by determining a conflict resolution rule that is strictest among the plurality of the conflict resolution rules.

In one embodiment, the processor raises an error case upon determining that a plurality of conflict resolution rules are inconsistent.

In one embodiment, the processor determines which of the first cell and the second cell is the reference cell based on a first subcarrier spacing associated with the first symbol and a second subcarrier spacing associated with the second symbol.

In one embodiment, the processor determines which of the first cell and the second cell is the reference cell based on a first subcarrier spacing associated with the first cell and a second subcarrier spacing associated with the second cell.

A third method is disclosed for dual connectivity enhancements in integrated access and backhaul. The third method may be performed by a UE as described herein, for example, the remote unit 105 and/or the user equipment apparatus 1300, or a network device such as a base unit 121, a gNB, and/or the network equipment apparatus 1400. In some embodiments, the third method may be performed by a processor executing program code, for example, a microcontroller, a microprocessor, a CPU, a GPU, an auxiliary processing unit, a FPGA, or the like.

In one embodiment, the third method receives a first attribute associated with a first symbol on a first cell, the first attribute comprising a first downlink or a first uplink value and receives a second attribute associated with a second symbol on a second cell, the second attribute comprising a second downlink or a second uplink value, the second symbol overlapping with the first symbol in a time domain.

In one embodiment, the third method determines which of the first cell and the second cell is a reference cell, and in response to determining that the first cell is the reference cell, neglects a second operation associated with the second symbol, and in response to determining that the second cell is the reference cell, neglects a first operation associated with the first symbol.

In one embodiment, the third method determines which of the first cell and the second cell is the reference cell by determining whether a first timing alignment associated with the first symbol or a second timing alignment associated with the second symbol is a transmission timing alignment or a reception timing alignment.

In one embodiment, the third method determines which of the first cell and the second cell is the reference cell based on at least one of a first quality-of-service parameter associated with the first symbol or a second quality-of-service parameter associated with the second symbol.

In one embodiment, the third method determines which of the first cell and the second cell is the reference cell based on a plurality of conflict resolution rules and by determining a conflict resolution rule that is strictest among the plurality of the conflict resolution rules.

In one embodiment, the third method raises an error case upon determining that a plurality of conflict resolution rules are inconsistent.

In one embodiment, the third method determines which of the first cell and the second cell is the reference cell based on a first subcarrier spacing associated with the first symbol and a second subcarrier spacing associated with the second symbol.

In one embodiment, the third method determines which of the first cell and the second cell is the reference cell based on a first subcarrier spacing associated with the first cell and a second subcarrier spacing associated with the second cell.

A fourth apparatus is disclosed for dual connectivity enhancements in integrated access and backhaul. The fourth apparatus may include a UE as described herein, for example, the remote unit 105 and/or the user equipment apparatus 1300, or a network device such as a base unit 121, a gNB, and/or the network equipment apparatus 1400. In some embodiments, the fourth apparatus includes a processor executing program code, for example, a microcontroller, a microprocessor, a CPU, a GPU, an auxiliary processing unit, a FPGA, or the like.

In one embodiment, the fourth apparatus includes a transceiver that receives a first attribute associated with a first symbol for a first mobile terminal (“MT”) functionality, the first attribute comprising a first downlink or a first uplink value and receives a second attribute associated with a second symbol for a second MT functionality, the second attribute comprising a second downlink or a second uplink value, the second symbol overlapping with the first symbol in a time domain.

In one embodiment, the fourth apparatus includes a processor that determines which of the first MT and the second MT is a reference MT, and in response to determining that the first MT is the reference MT, neglects a second operation associated with the second symbol, and in response to determining that the second MT is the reference MT, neglects a first operation associated with the first symbol.

A fourth method is disclosed for dual connectivity enhancements in integrated access and backhaul. The fourth method may be performed by a UE as described herein, for example, the remote unit 105 and/or the user equipment apparatus 1300, or a network device such as a base unit 121, a gNB, and/or the network equipment apparatus 1400. In some embodiments, the fourth method may be performed by a processor executing program code, for example, a microcontroller, a microprocessor, a CPU, a GPU, an auxiliary processing unit, a FPGA, or the like.

In one embodiment, the fourth method receives a first attribute associated with a first symbol for a first mobile terminal (“MT”) functionality, the first attribute comprising a first downlink or a first uplink value and receives a second attribute associated with a second symbol for a second MT functionality, the second attribute comprising a second downlink or a second uplink value, the second symbol overlapping with the first symbol in a time domain.

In one embodiment, the fourth method determines which of the first MT and the second MT is a reference MT, and in response to determining that the first MT is the reference MT, neglects a second operation associated with the second symbol, and in response to determining that the second MT is the reference MT, neglects a first operation associated with the first symbol.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A wireless network apparatus, the apparatus comprising:
a transceiver that:
receives a first attribute associated with a first symbol on a first cell, the first attribute comprising a first downlink or a first uplink value;
receives a second attribute associated with a second symbol on a second cell, the second attribute comprising a second downlink or a second uplink value, the second symbol overlapping with the first symbol in a time domain; and
receives first information of a first timing alignment for the first cell and second information of a second timing alignment for the second cell; and
a processor that:
determines which of the first cell and the second cell is a reference cell based on the first information of the first timing alignment and the second information of the second timing alignment;
in response to determining that the first cell is the reference cell, neglects a second operation associated with the second symbol; and
in response to determining that the second cell is the reference cell, neglects a first operation associated with the first symbol.

2. The apparatus of claim 1, wherein the processor determines which of the first cell and the second cell is the reference cell by determining whether the first timing alignment or the second timing alignment is a transmission timing alignment or a reception timing alignment.

3. The apparatus of claim 1, wherein the transceiver receives at least a first availability indication associated with the first symbol and a second availability indication associated with the second symbol and the processor determines which of the first cell and the second cell is the reference cell based, at least in part, on at least one of the first availability indication and the second availability indication.

4. The apparatus of claim 1, wherein the processor further determines which of the first cell and the second cell is the reference cell based on a multiplexing capability of the apparatus.

5. The apparatus of claim 4, wherein the multiplexing capability indicates whether the apparatus is capable of time division multiplexing only.

6. The apparatus of claim 4, wherein the multiplexing capability is communicated to at least one of a parent node, an integrated access and backhaul central unit (IAB-CU), or a network configuration entity.

7. The apparatus of claim 1, wherein the processor further determines which of the first cell and the second cell is the reference cell based on a multi-panel capability.

8. The apparatus of claim 7, wherein the multi-panel capability is communicated to at least one of a parent node, an integrated access and backhaul central unit (IAB-CU), or a network configuration entity.

9. The apparatus of claim 1, wherein the transceiver receives, from a first base station associated with the first cell, a coordination signaling and transmits the coordination signaling to a second based station associated with the second cell.

10. The apparatus of claim 1, wherein a first base station associated with the first cell and a second based station associated with the second cell communicate coordination signaling over an F1 interface.

11. A wireless network apparatus, the apparatus comprising:
a transceiver that:
receives a first attribute associated with a first symbol on a first cell, the first attribute comprising a first downlink or a first uplink value; and
receives a second attribute associated with a second symbol on a second cell, the second attribute comprising a second downlink or a second uplink value, the second symbol overlapping with the first symbol in a time domain; and
a processor that:
determines which of the first cell and the second cell is a reference cell;
in response to determining that the first cell is the reference cell, neglects a second operation associated with the second symbol; and
in response to determining that the second cell is the reference cell, neglects a first operation associated with the first symbol.

12. The apparatus of claim 11, wherein the processor determines which of the first cell and the second cell is the reference cell by determining whether a first timing alignment associated with the first symbol or a second timing alignment associated with the second symbol is a transmission timing alignment or a reception timing alignment.

13. The apparatus of claim 11, wherein the processor determines which of the first cell and the second cell is the reference cell based on at least one of a first quality-of-service parameter associated with the first symbol or a second quality-of-service parameter associated with the second symbol.

14. The apparatus of claim 11, wherein the processor determines which of the first cell and the second cell is the reference cell based on a first subcarrier spacing associated with the first symbol and a second subcarrier spacing associated with the second symbol.

15. A wireless network apparatus, the apparatus comprising:
a transceiver that:
receives a first attribute associated with a first symbol for a first mobile terminal (“MT”) functionality, the first attribute comprising a first downlink or a first uplink value; and
receives a second attribute associated with a second symbol for a second MT functionality, the second attribute comprising a second downlink or a second uplink value, the second symbol overlapping with the first symbol in a time domain; and
a processor that:
determines which of the first MT and the second MT is a reference MT;
in response to determining that the first MT is the reference MT, neglects a second operation associated with the second symbol; and
in response to determining that the second MT is the reference MT, neglects a first operation associated with the first symbol.
